(19) United States
(12) Patent Application Publication
(10) Pub. No.: US 2022/0255133 A1
(43) Pub. Date: Aug. 11, 2022

(54) NONAQUEOUS ELECTROLYTE, SECONDARY BATTERY, BATTERY PACK, VEHICLE, AND STATIONARY POWER SUPPLY

(71) Applicant: KABUSHIKI KAISHA TOSHIBA, Tokyo (JP)

(72) Inventors: Norio Takami, Yokohama Kanagawa (JP); Tomoko Sugizaki, Kawasaki Kanagawa (JP)

(73) Assignee: KABUSHIKI KAISHA TOSHIBA, Tokyo (JP)

(21) Appl. No.: 17/408,235

(22) Filed: Aug. 20, 2021

(30) Foreign Application Priority Data
Feb. 3, 2021 (JP) 2021-015758
Jul. 8, 2021 (JP) 2021-113631

(51) Int. Cl. H01M 10/0569; H01M 10/052; H01M 4/38

(52) U.S. Cl. CPC H01M 10/0569; H01M 2004/027; H01M 4/382; H01M 10/052

(57) ABSTRACT

According to one embodiment, a nonaqueous electrolyte including an ionic liquid is provided. The ionic liquid includes: a cation including trialkyl sulfonium ions and lithium ions; a first anion of [N(FSO₂)₂]⁻; and a second anion including one or more selected from the group consisting of [N(CF₃SO₂)₂]⁻, [N(FSO₂)(CF₃SO₂)]⁻, [N(FSO₂)(C₂F₅SO₂)]⁻, [N(FSO₂)(n-C₄F₉SO₂)]⁻, PF₆⁻, and BF₄⁻. A molar ratio between the first anion and the second anion is in the range of 1:4 to 4:1. A molar ratio between the lithium ions and the trialkyl sulfonium ions is in the range of 1:4 to 4:1.

### CROSS-REFERENCE TO RELATED APPLICATIONS

This application is based upon and claims the benefit of priority from Japanese Patent Applications No. 2021-015758, filed Feb. 3, 2021, and No. 2021-113631 filed Jul. 8, 2021, the entire contents of all of which are incorporated herein by reference.

### FIELD

Embodiments described herein generally relate to a nonaqueous electrolyte, a secondary battery, a battery pack, a vehicle, and a stationary power supply.

### BACKGROUND

Nonaqueous electrolyte batteries using lithium metal, lithium alloys, lithium compounds, or carbonaceous materials for a negative electrode have been envisaged for a battery having a high energy density, and have therefore been actively researched and developed. So far, a lithium ion battery that has a positive electrode including LiCoO₂ or LiMn₂O₄ as an active material, and a negative electrode including a carbonaceous material having lithium ions inserted and extracted has been widely commercialized for portable devices. To promote its applicability to electric automobiles and/or stationary storage batteries, not only enhancing the energy density and capacity of a secondary battery but also improving its durability-life performance, low-temperature performance, and safety have been demanded. To enhance the energy density of a secondary battery, a battery including a metal negative electrode (e.g., Li, Na, Mg, Al), a battery having a positive electrode including sulfur, or a battery using an air electrode for the positive electrode have been researched and developed as a post-lithium ion battery; however, it has been difficult to achieve both a high energy density and durability-life performance.

In the battery including a metal negative electrode, the use of Li metal for the metal negative electrode poses a problem such as the incidence of a short circuit due to dendrite deposition, and the use of Mg metal for the metal negative electrode increases the risk of an overvoltage and causes difficulty in the charge-and-discharge cycle. In recent years, an ionic liquid having an ambient temperature made of cations and anions has been researched as an electrolytic solution of a lithium secondary battery which uses a Li metal negative electrode, as it can be expected to provide a high degree of safety with its non-volatile, non-combustible, and non-flammable properties. However, when the ionic liquid is decomposed by an oxidation-reduction reaction, the cycle of the secondary battery degrades considerably and it is difficult to perform a low-temperature operation. Therefore, a lithium secondary battery using an ionic liquid has proven difficult to put into practice.

### BRIEF DESCRIPTION OF THE DRAWINGS

FIG. 1 is a cross-sectional view of a secondary battery according to an embodiment, taken in parallel with a first direction.

FIG. 2 is a cross-sectional view of another secondary battery according to the embodiment, taken in parallel with the first direction.

FIG. 3 is an exploded perspective view schematically showing an example of a battery pack according to an embodiment.

FIG. 4 is a block diagram showing an example of an electric circuit of the battery pack shown in FIG. 3.

FIG. 5 is a cross-sectional view schematically showing an example of a vehicle according to an embodiment.

FIG. 6 is a block diagram showing an example of a system including a stationary power supply according to an embodiment.

### DETAILED DESCRIPTION

According to an embodiment, an object is to provide a secondary battery exhibiting excellent high-temperature cycle life performance and low-temperature performance, a battery pack including the secondary battery, a vehicle, and a stationary power supply.

Also, according to an embodiment, it is possible to provide a nonaqueous electrolyte capable of realizing a secondary battery exhibiting excellent cycle life performance and discharge performance, a secondary battery exhibiting excellent cycle life performance and discharge performance, a battery pack including the secondary battery, a vehicle, and a stationary power supply.

According to an embodiment, a secondary battery including a positive electrode, a negative electrode, and a liquid nonaqueous electrolyte is provided. The negative electrode includes lithium metal and/or a lithium alloy as a negative electrode active material. The liquid nonaqueous electrolyte contains an ionic liquid and 0.5% by weight to 30% by weight of an organic fluorine compound. The ionic liquid includes: a cation including trialkyl sulfonium ions and lithium ions; and an anion including one or more selected from the group consisting of [N(CF₃SO₂)₂]⁻, [N(FSO₂)₂]⁻, [N(FSO₂)(CF₃SO₂)]⁻, [N(FSO₂)(C₂F₅SO₂)]⁻, [N(FSO₂)(n-C₄F₉SO₂)]⁻, Cl⁻, PF₆⁻, and BF₄⁻.

According to an embodiment, a nonaqueous electrolyte including an ionic liquid is provided. The ionic liquid includes: a cation including trialkyl sulfonium ions and lithium ions; a first anion of [N(FSO₂)₂]⁻; and a second anion including one or more selected from the group consisting of [N(CF₃SO₂)₂]⁻, [N(FSO₂)(CF₃SO₂)]⁻, [N(FSO₂)(C₂F₅SO₂)]⁻, [N(FSO₂)(n-C₄F₉SO₂)]⁻, PF₆⁻, and BF₄⁻. A molar ratio between the first anion and the second anion is in the range of 1:4 to 4:1. A molar ratio between the lithium ions and the trialkyl sulfonium ions is in the range of 1:4 to 4:1.

According to an embodiment, there is provided a secondary battery including a positive electrode capable of having lithium ions inserted and extracted, a negative electrode capable of having lithium ions inserted and extracted, and the nonaqueous electrolyte of the embodiment.

According to an embodiment, a battery pack including the secondary battery according to the embodiment is provided.

According to an embodiment, a vehicle including the battery pack according to the embodiment is provided.

Also, according to an embodiment, a stationary power supply including the battery pack according to the embodiment is provided.

### First Embodiment

According to a first embodiment, a secondary battery including a positive electrode, a negative electrode, and a liquid nonaqueous electrolyte is provided. The negative electrode includes lithium metal and/or a lithium alloy as a negative electrode active material. The liquid nonaqueous electrolyte contains an ionic liquid and 0.5% by weight to 30% by weight of an organic fluorine compound. The ionic liquid is essentially or substantially composed of: a cation essentially or substantially consisting of trialkyl sulfonium ions and lithium ions; and an anion essentially or substantially consisting of one or more selected from the group consisting of [N(CF₃SO₂)₂]⁻, [N(FSO₂)₂]⁻, [N(FSO₂)(CF₃SO₂)]⁻, [N(FSO₂)(C₂F₅SO₂)]⁻, [N(FSO₂)(n-C₄F₉SO₂)]⁻, Cl⁻, PF₆⁻, and BF₄⁻.

Trialkyl sulfonium ions expand the electrochemical window of the secondary battery to enable a high-voltage operation of the secondary battery. However, a secondary battery including a nonaqueous electrolytic solution made of an ionic liquid including trialkyl sulfonium ions and a negative electrode including lithium metal and/or a lithium alloy as negative electrode active material(s) has the drawback of its charge-and-discharge cycle life decreasing rapidly in a high-temperature environment. This is because the nonaqueous electrolytic solution is decomposed by a reduction reaction in a high-temperature environment to cause a high-resistance coating containing sulfur to grow on the surface of the negative electrode.

Having 0.5% by weight to 30% by weight of an organic fluorine compound contained in a liquid nonaqueous electrolyte which includes an ionic liquid composed of an anion and a cation including trialkyl sulfonium ions can decrease the viscosity of the liquid nonaqueous electrolyte; therefore, the nonaqueous electrolyte can be permeated evenly into the positive electrode and the negative electrode. By coming into contact with the negative electrode, said nonaqueous electrolyte can form a low-resistance artificial protective film on the surface of the negative electrode immediately, that is, before initial charge is performed. As a result, reductive decomposition of the trialkyl sulfonium ions can be suppressed to a great degree, which leads to reduced interface resistance between the negative electrode and the nonaqueous electrolyte and significant improvement of the cycle life performance of the secondary battery. Also, since the viscosity of the liquid nonaqueous electrolyte can be decreased, the low-temperature performance of the secondary battery can be improved.

Further, the negative electrode including lithium metal and/or a lithium alloy as a negative electrode active material contributes to improvement of the energy density of the secondary battery.

Therefore, the embodiment can provide a secondary battery having a high energy density and exhibiting excellent high-temperature cycle performance and low-temperature performance.

The secondary battery according to the embodiment may further include a separator and a container member. Hereinafter, the positive electrode, the nonaqueous electrolyte, the negative electrode, the separator, and the container member will be described.

### (1) Positive Electrode

The positive electrode includes: a positive electrode active material-containing layer including a positive electrode active material; and a positive electrode current collector in contact with the positive electrode active material-containing layer.

When discharge is to be started first, the positive electrode active material may include a halide including one or more metal elements selected from the group consisting of copper, iron, nickel, cobalt, tin, and zinc. As halogen ions, fluorine ions (F⁻) and chlorine ions (Cl⁻) are preferred. This is because a high voltage can be obtained and because a charge reaction proceeds smoothly. As preferred metal halides, CuFₓ (0<x≤2), CuClₓ (0<x≤2), FeFₓ (0<x≤3), FeClₓ (0<x≤3), NiClₓ (0<x≤2), CoFₓ (0<x≤3), CoClₓ(0<x≤3), SnClₓ (0<x≤2), and ZnCl₂ can be cited. More preferred metal halides are CuCl₂, CuF₂, and FeF₃. This is because these halides can achieve a high voltage and a high capacity. The number of kinds of halide to be used can be one, two, or more. Also, when discharge is to be started first, a metal oxide or a metal sulfide may be used as a positive electrode active material. As the metal oxide, a titanium-containing oxide, a titanium-niobium-containing oxide, a titanium-niobium-molybdenum-containing oxide, a niobium-containing oxide, a vanadium-containing oxide, a manganese-containing oxide, and an iron-containing oxide can be cited. Examples of the titanium-containing oxide include TiO₂, TiO₂(B), and Li₄Ti₅O₁₂. Examples of the titanium-niobium-containing oxide include TiNb₂O₇. Examples of the titanium-niobium-molybdenum-containing oxide include Ti_{0.2}NbMo_{0.6}O₇. Examples of the niobium-containing oxide include Nb₂O₅. Examples of the vanadium-containing oxide include V₂O₅. Examples of the manganese-containing oxide include MnO₂. Examples of the iron-containing oxide include FePO₄. TiNb₂O₇ and Li₄Ti₅O₁₂ are more preferred. This is because these oxides contribute to improvement of the cycle performance. Examples of the metal sulfide include TiS₂, FeS₂, FeS, CuS, Cu₂S, and NiS. FeS and CuS are more preferred. This is because these sulfides contribute to capacity improvement.

On the other hand, when charge is to be started first, a mixture of lithium halide and one or more metal elements selected from the group consisting of copper, iron, nickel, cobalt, tin, and zinc may be used as a positive electrode active material. The metal elements may be in the form of particles. An average particle size (diameter) of metal particles can be set to 0.01 μm to 100 μm. The average particle size is more preferably 0.1 μm to 10 μm. Also, when charge is to be started first, a lithium metal oxide which allows lithium ions to be inserted and extracted may be used. Examples of the lithium metal oxide include lithium-cobalt oxides (Li_{y}CoO₂, 0<y≤1.1), lithium-nickel-cobalt-manganese oxides (Li_{y}NiₐCo_{b}Mn_{c}O₂, a+b+c=1, 0<a, 0<b, 0<c, 0<y≤1.1), lithium-nickel-cobalt-aluminum oxides (Li_{y}NiₐCo_{b}Al_{c}O₂, a+b+c=1, 0<a, 0<b, 0<c, 0<y≤1.1), lithium iron phosphates (Li_{y}FePO₄, 0<y≤1.1), fluorinated lithium iron sulfates (Li_{y}FeSO₄F, 0<y≤1.1), iron lithium manganese phosphates (Li_{y}Mn₁₋ₐFeₐPO₄, 0<a<0.5, 0<y≤1.1), lithium-manganese oxides (LiMn₂O₄), and lithium-nickel-manganese oxides (LiNi_{0.5}Mn_{1.5}O₄).

One, or two or more kinds of positive electrode active materials may be used.

The positive electrode active material-containing layer may include an electro-conductive agent. Examples of the electro-conductive agent include carbon materials such as carbon nanofibers, acetylene black, and graphite. The aforementioned carbon materials can improve the network of electrons in the positive electrode. One, or two or more kinds of electro-conductive agents may be used. The proportion of the electro-conductive agent in the positive electrode active material-containing layer (excluding the weight of the nonaqueous electrolyte) is preferably from 5% by weight to 40% by weight.

The positive electrode active material-containing layer may include a binder. Examples of the binder include polyethylene terephthalate, polysulfone, polyimide, cellulose, rubber, and polyvinylidene fluoride (PVdF). The aforementioned binders exhibit excellent chemical stability against the nonaqueous electrolyte. The proportion of the binder in the positive electrode active material-containing layer (excluding the weight of the nonaqueous electrolyte) is preferably from 1% by weight to 10% by weight.

Examples of the positive electrode current collector include a porous material, mesh or foil made of one or more metal elements selected from the group consisting of copper, stainless steel, iron, aluminum, nickel, cobalt, tin, and zinc. Preferred examples of the metal elements include copper, stainless steel, nickel, iron, and an alloy including one or more of these. This prevents the surface of the positive electrode current collector from being dissolved during over-charge, thereby reducing the resistance of the positive electrode and allowing for suppression of an over-charge reaction, leading to improved safety. Also, the positive electrode current collector including the above metal elements has excellent corrosion resistance. The thickness of the positive electrode current collector is preferably from 10 μm to 20 μm. The porosity of the porous material is preferably from 30% to 98%. The porosity of the porous material is more preferably from 50% to 60%. The positive electrode including CuCl₂ and/or CuF₂ can achieve a high voltage, and the use of Cu for its current collector allows at least a part of the current collector to be used as an active material. As a result, there will be one flat-voltage part between the discharge voltages of 2.8 V to 2.5 V.

The thickness of the positive electrode varies depending on the shapes and applications of the electrode. When the electrode group takes a stacked structure or a wound structure, the thickness of the positive electrode is preferably from 30 μm to 100 μm in a high-output application, and from 100 μm to 500 μm in a high-energy application.

### (2) Nonaqueous Electrolyte

The liquid nonaqueous electrolyte is neither a gel nor a solid. The liquid nonaqueous electrolyte is, in effect, composed of an ionic liquid and an organic fluorine compound, for example. Also, in the liquid nonaqueous electrolyte, the ionic liquid and the organic fluorine compound may be present in the form of a mixture.

The liquid nonaqueous electrolyte may be highly viscous when the concentration of lithium ions increases. The viscosity of the liquid nonaqueous electrolyte may be in the range of 1 cP to 1000 cP at 25° C. A liquid nonaqueous electrolyte satisfying this range shows a high viscosity; however, the transport number of lithium ions can be increased, and the charge transfer resistance at the electrode surface can be decreased.

It is desirable that the liquid nonaqueous electrolyte be in contact with, be included in, or be held in at least the negative electrode. Thereby, a protective coating can be formed evenly on the surface of the negative electrode. A liquid nonaqueous electrolyte which comes into contact with the positive electrode may not contain the organic fluorine compound. In this case, an ionic liquid may be used as the liquid nonaqueous electrolyte which comes into contact with the positive electrode. A liquid nonaqueous electrolyte which comes into contact with, or is included or held in the negative electrode may be referred to as a “first liquid nonaqueous electrolyte”, and a liquid nonaqueous electrolyte which comes into contact with, or is included or held in the positive electrode may be referred to as a “second liquid nonaqueous electrolyte”. When a common liquid nonaqueous electrolyte is used for both the positive electrode and the negative electrode, it is desirable that the liquid nonaqueous electrolyte come into contact with at least one of the positive electrode or the negative electrode, or be included or held in at least one of the positive electrode, the negative electrode, or the separator. This can cause a charge-discharge reaction to occur smoothly.

When the positive electrode active material-containing layer of the positive electrode has a porous structure, the proportion of the nonaqueous electrolyte in the positive electrode active material-containing layer is preferably in the range of 10% by weight to 60% by weight. By setting the proportion to 10% by weight or more, the effective area for the electrochemical reaction can be increased to improve the battery capacity and suppress the resistance. By setting the proportion to 60% by weight or less, the positive electrode weight proportion can be increased to improve the battery capacity.

The ionic liquid may be essentially or substantially composed of a cation and an anion.

Lithium ions as cations may be supplied, for example, from a lithium salt. Examples of the lithium salt include LiCl, LiBF₄, LiPF₆, LiN(FSO₂)₂, LiN(CF₃SO₂)₂, Li[N(FSO₂)(CF₃SO₂)], Li[N(FSO₂)(C₂F₅SO₂)], and Li[N(FSO₂)(n-C₄F₉SO₂)]. One, or two or more kinds of lithium salts may be used. The amount of the lithium salt dissolved in the ionic liquid is preferably from 0.3 mol/kg to 2 mol/kg. When the amount of dissolution is in this range, the interface resistance of the metal lithium can be reduced, leading to large-current characteristics, suppression of dendrite deposition, and greatly improved cycle life performance. LiN(FSO₂)₂, LiN(CF₃SO₂)₂, Li[N(FSO₂)(CF₃SO₂)], Li[N(FSO₂)(C₂F₅SO₂)], and Li[N(FSO₂)(n-C₄F₉SO₂)] are abbreviated as LiFSI, LiTFSI, LiFTFSI, LiFPFSI, and LiFNFSI, respectively.

Trialkyl sulfonium ions as cations have a framework shown in Chemical Formula 1 below and are paired with anions. Trialkyl sulfonium ions are trimethylsulfonium ions (S(CH₃)₃⁺: abbreviated S111), triethylsulfonium ions (S(C₂H₅)₃⁺: abbreviated S222), diethylpropylsulfonium ions (S(C₂H₅)₂(C₃H₇)⁺: abbreviated S223), and methylethylpropylsulfonium ions (S(CH₃)(C₂H₅)(C₃H₇)⁺: abbreviated S123). Triethylsulfonium ions (S222) and methylethylpropylsulfonium ions (S123) are preferred. This is because having the respective cations contained in the ionic liquid decreases the melting point of this liquid and increases ionic conductivity.

On the other hand, Cl⁻, BF₄⁻, PF₆⁻, [N(CF₃SO₂)₂]⁻, [N(FSO₂)₂]⁻, [N(FSO₂)(CF₃SO₂)]⁻, [N(FSO₂)(C₂F₅SO₂)]⁻, and [N(FSO₂)(n-C₄F₉SO₂)]⁻ are included as anions. More preferred anions are [N(CF₃SO₂)₂]⁻, [N(FSO₂)₂]⁻, [N(FSO₂)(CF₃SO₂)]⁻, [N(FSO₂)(C₂F₅SO₂)]⁻, and [N(FSO₂)(n-C₄F₉SO₂)]⁻ because each of them has an effect of reducing the interface resistance of the negative electrode.

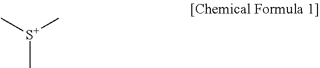

Further, since the ionic liquid containing the above ions has high electrochemical stability, its reactivity with the positive electrode in the charge-discharge reaction at the positive electrode can be lowered. When the above halides are used for the positive electrode active material, the efficiency of the charge-discharge reactions depending on the dissolution-deposition reactions of the positive electrode active material can be increased, leading to improved cycle life performance. Further, self-discharge can be suppressed, and excellent storage performance can be achieved. In addition, the ionic liquid containing the above ions may suppress an overcharge reaction and an overdischarge reaction. When the above halides are used for the positive electrode active material, metal deposition occurs due to the reduction reaction of the metal elements of the halides as the discharge reaction proceeds, and the concentration of lithium halide (LiCl or LiF) also increases. When the concentration of lithium halide reaches supersaturation, lithium halide is deposited. As a result, in the overdischarge state, the ionic conductivity of the ionic liquid in the positive electrode decreases, leading to solidification of the ionic liquid. The overdischarge reaction ceases accordingly, thereby suppressing deterioration of the positive electrode due to the overdischarge. On the other hand, as the charge reaction proceeds, the deposited metal element is oxidized and eluted, and then deposited as a metal halide. In the overcharge reaction, since lithium ions in the positive electrode are depleted, ionic conduction in the lithium-ion conductive separator ceases. As a result, the overcharge reaction ceases, thereby suppressing deterioration of the positive electrode due to the overcharge reaction. Through such a reaction mechanism, the secondary battery will have a greatly improved safety and durability against the overcharge reaction and the overdischarge reaction, which can eliminate the need for a circuit for preventing overcharge and overdischarge.

A liquid nonaqueous electrolyte which comes into contact with the negative electrode (and can be referred to as a “first liquid nonaqueous electrolyte”) contains an organic fluorine compound. The organic fluorine compound is made of one or more selected from the group consisting of fluorinated ester and fluorinated ether. In a high-temperature environment, the ionic liquid containing trialkyl sulfonium ions is decomposed, in particular by a lithium metal (Li) negative electrode, through a reduction reaction. As a result, the resistance of the coating on the surface of the negative electrode increases, causing the charge-and-discharge cycle life of the secondary battery to decrease rapidly. Therefore, having the liquid nonaqueous electrolyte contain an organic fluorine compound in a proportion of 0.5% by weight to 30% by weight with respect to the total weight of the liquid nonaqueous electrolyte can form a low-resistance artificial protective film containing fluorine on the surface of the negative electrode as the liquid nonaqueous electrolyte comes into contact with the negative electrode. Accordingly, growth of a high-resistance coating containing sulfur can be suppressed, whereby reductive decomposition of the trialkyl sulfonium ions can be greatly suppressed during charge and discharge at a large current density and in a high-temperature environment, leading to a reduced interface resistance and greatly improved cycle life performance. Also, having the liquid nonaqueous electrolyte contain 10% by weight to 30% by weight of fluorinated ester and/or fluorinated ether can decrease the viscosity of the nonaqueous electrolyte, leading to particularly improved low-temperature performance. Preferred examples of fluorinated ester include fluoroethylene carbonate (FEC), difluoroethylene carbonate (DFEC), and 2,2,2-trifluoroethylmethylcarbonate (TFEMC). On the other hand, as the fluorinated ether, 1,1,2,2-tetrafluoro-2,2,2-trifluoroethylether (HFE) can be cited. The use of these organic fluorine compounds can form a low-resistance artificial protective coating containing fluorine on the surface of the negative electrode without undergoing initial charge as the liquid nonaqueous electrolyte comes into contact with the negative electrode. Accordingly, growth of a high-resistance coating containing sulfur can be suppressed, whereby reductive decomposition of the trialkyl sulfonium ions occurring in the negative electrode can be suppressed even during charge and discharge at a large current density and in a high-temperature environment, leading to a reduced interface resistance and greatly improved cycle life performance. In addition, setting the amount of the organic fluorine compound added to 10% by weight to 30% by weight can decrease the viscosity of the nonaqueous electrolyte and improve the low-temperature performance. Also, since the amount of the lithium salt dissolved in the ionic liquid can be increased, the concentration of lithium ions in the nonaqueous electrolyte can be increased and concentration overvoltage can be reduced.

The liquid nonaqueous electrolyte may contain an organic fluoride in order to further decrease the viscosity. Examples of the organic fluoride include 3,3,3-trifluoromethyl propionate (FMP) and 2,2,2-trifluoroethyl acetate (FEA).

### (3) Negative Electrode

The negative electrode includes one or more selected from the group consisting of lithium metal and a lithium alloy as a negative electrode active material. One, or two or more kinds of negative electrode active materials may be used. When the negative electrode and the liquid nonaqueous electrolyte come into mutual contact, a favorable coating can be formed on the surface of the negative electrode by the reductive decomposition of the organic fluorine compound.

Since a negative electrode including lithium metal has a high capacity and a high battery voltage and can be reduced in weight, the energy density of a secondary battery can be increased.

Examples of the lithium alloy include alloys such as Li—Al, Li—Si, Li—Zn, and Li—Mg. A more preferred alloy is Li—Mg alloy which suppresses Li dendrite deposition. The content molar ratio of Mg is preferably in the range of 0.05 to 0.15.

The lithium metal and the lithium alloy are preferably in the form of a foil.

The negative electrode may further include a negative electrode current collector. Examples of the negative electrode current collector include a foil or mesh including a metal, such as copper or nickel. The negative electrode current collector may be in contact with a lithium metal layer or a lithium alloy layer. The negative electrode current collector is preferably electrically connected to a negative electrode terminal via a lead.

The capacity of the negative electrode is preferably equal to or larger than that of the positive electrode.

The thickness of the negative electrode varies depending on the shapes and applications of the electrode. When the electrode group takes a stacked structure or a wound structure, the thickness of the negative electrode is preferably from 30 μm to 500 μm.

### (4) Separator

As the separator, a non-woven fabric, a porous film, and a lithium-ion conductive solid electrolyte film can be used. One, or two or more kinds of separators can be used. Examples of the material forming the non-woven fabric include polymeric fibers (such as cellulose, polyacrylonitrile (PAN), and polyimide), and inorganic fibers (such as alumina and silica). As the porous film, a polyethylene (PE) film, a polypropylene (PP) film, or a polyimide film is used. Since the ionic liquid has a high viscosity, the separator preferably has a porosity as high as 60% to 80%. The thickness is preferably from 5 μm to 50 μm. Also, to maintain high insulation from the negative electrode made of lithium metal and/or a lithium alloy, it is preferable to form a layer of inorganic oxide particles on at least a part of the surface of the separator, on at least a part of the surface of the positive electrode which comes into contact with the separator, or on at least a part of the surface of the negative electrode which comes into contact with the separator. Examples of the inorganic oxide particles include alumina particles, titania particles, and lithium-conductive solid electrolyte particles. The layer of inorganic oxide particles may contain a binder such as polyvinylidene fluoride. A layer of a lithium-ion conductive solid electrolyte film and a non-woven fabric, or a layer of a lithium-ion conductive solid electrolyte film and a porous film may be used as a separator.

A separator made of a lithium-ion conductive solid electrolyte is a film or layer which is selectively permeable to lithium ions, that is, impermeable to cations other than lithium. Incidentally, metal ions of the positive electrode active material may be dissolved in a nonaqueous electrolyte which comes into contact with the surface of the positive electrode. When the metal ions pass through the separator to reach the negative electrode, self-discharge occurs. Therefore, it is preferable that a separator made of a lithium-ion conductive solid electrolyte have a non-communicating structure with no through-holes, or be free from holes. Such a structure prevents the metal ions from passing through the separator and thus greatly suppresses self-discharge, leading to excellent storage performance. It can also prevent a short circuit caused by dendrite deposition of the lithium metal negative electrode.

Examples of the lithium-ion conductive separator include an oxide having lithium-ionic conductivity, a sulfide having lithium-ionic conductivity, a phosphorus oxide having lithium-ionic conductivity, a polymer having lithium-ionic conductivity, a solid electrolyte having lithium-ionic conductivity, and a composite obtained by combining two or more of the respective components. The lithium-ion conductive separator may be a composite further including an inorganic material and/or an organic material in addition to the above components.

The lithium-ion conductive separator may be in the form of a layer or a film.

As the lithium-ion conductive separator, a flexible separator which is a composite of a lithium-ion conductive inorganic solid electrolyte and a polymer may be used. This separator is selectively permeable to lithium ions, and is free from holes or has a non-communicating structure. Examples of the polymer include polyethylene oxide (PEO), polyethylene terephthalate, polyvinylidene fluoride (PVdF). The polymer may contain either a lithium salt in an amount of 50% by weight or less or no lithium salt. Preferred examples of the lithium salt are LiFSI, LiTFSI, LiFTFSI, LiFPFSI, and LiFNFSI. The inorganic solid electrolyte is preferably contained in the composite electroyte in the range of 10% by weight to 90% by weight. By using this separator, only the lithium ions can selectively move in the separator, so that ions other than the lithium ions in the positive electrode and ions other than the lithium ions in the negative electrode are restricted from passing through the separator.

Examples of the lithium-ion conductive solid electrolyte include an oxide solid electrolyte having a garnet-type structure and a lithium phosphate solid electrolyte having a NASICON-type structure. The oxide solid electrolyte having a garnet-type structure is highly resistant to reduction and has an advantage of a wide electrochemical window. Examples of the oxide solid electrolyte having a garnet-type structure include Li₅₊ₓAₓLa₃₋ₓM₂O₁₂ (A is one or more selected from the group consisting of Ca, Sr, and Ba, M is one or more selected from the group consisting of Nb and Ta, 0≤x≤0.5), Li₃M₂₋ₓL₂O₁₂ (M is one or more selected from the group consisting of Ta and Nb, L may include Zr, 0≤x≤0.5), Li₇₋₃ₓAlₓLa₃Zr₂O₁₂ (0≤x≤0.5), and Li₇La₃Zr₂O₁₂. Among them, Li_{6.25}Al_{0.25}La₃Zr₂O₁₂ and Li₇La₃Zr₂O₁₂ have high ionic conductivity and are electrochemically stable, and thus are excellent in discharge performance and cycle life performance.

Examples of the lithium phosphate solid electrolyte having a NASICON-type structure include those represented by LiM₂(PO₄)₃ (M is one or more selected from Ti, Ge, Sr, Zr, Sn, Al, and Ca). In particular, Li₁₊ₓAlₓGe₂₋ₓ(PO₄)₃ (0≤x≤0.5), Li₁₊ₓAlₓZr₂₋ₓ(PO₄)₃ (0≤x≤0.5), and Li₁₊ₓAlₓTi₂₋ₓ(PO₄)₃ (0≤x≤0.5) are preferable because they have high ionic conductivity and high electrochemical stability.

The separator preferably has a thickness of 20 μm to 200 μm. If the thickness falls below this range, the mechanical strength may decrease. If the thickness exceeds this range, the ion conduction resistance may increase.

### (5) Container Member

The secondary battery may include a container member. The container member includes a container having an opening, and a lid attachable to the opening of the container. The lid may be separate from or integral with the container. The container member is not limited to the structure shown in the drawings as long as the container member can house the positive electrode, the negative electrode, the separator, and the electrolyte. A container member having a shape corresponding to a prismatic, thin, cylindrical, or coin-shaped battery may be used.

Examples of the material constituting the container member include a metal and a laminated film.

Examples of the metal include iron, stainless steel, aluminum, and nickel. When a metallic can is used for the container, a plate thickness for the container is preferably 0.5 mm or less, and more preferably 0.3 mm or less.

Examples of the laminated film include a multilayer film formed of an aluminum foil or a stainless steel foil covered with a resin film. As the resin, a polymer such as polypropylene (PP), polyethylene (PE), nylon, or polyethylene terephthalate (PET) can be used. The thickness of the laminated film is preferably 0.2 mm or less.

A method of identifying components of the nonaqueous electrolyte will be described below.

First, a secondary battery to be measured is discharged at 1 C until the battery voltage becomes 1.0 V. The discharged secondary battery is disassembled inside a glove box in an inert atmosphere. Then, a nonaqueous electrolyte included in the battery and the electrode group is extracted. If the nonaqueous electrolyte can be extracted from the unsealed part of the battery, sampling of the nonaqueous electrolyte is performed as is. On the other hand, if the nonaqueous electrolyte to be measured is held in the electrode group, the electrode group is further disassembled, and the separator impregnated with the nonaqueous electrolyte, for example, is extracted. The nonaqueous electrolyte impregnated into the separator can be extracted using a centrifuge separator or the like. Thereby, sampling of the nonaqueous electrolyte can be performed. If the amount of the nonaqueous electrolyte included in the secondary battery is small, the nonaqueous electrolyte can also be extracted by immersing the electrodes and the separator in an acetonitrile solution. The weight of the acetonitrile solution is measured before and after the extraction, so that the extraction amount can be calculated.

A sample of the nonaqueous electrolyte thus obtained is subjected to, for example, gas chromatography-mass spectrometry (GC-MS) or nuclear magnetic resonance (NMR) to perform a composition analysis. In the analysis, the components included in the nonaqueous electrolyte are identified first. Then, a calibration curve of each component is generated. If multiple kinds of components are included, a calibration curve for each component is generated. The composition of the nonaqueous electrolyte can be determined by comparing the generated calibration curve and the peak intensity or area shown in the results obtained by measuring the sample of the nonaqueous electrolyte.

In addition, the viscosity of the nonaqueous electrolyte can be measured by using the above sample of the nonaqueous electrolyte and, for example, a viscosity/viscoelasticity measurement apparatus, HAAKE MARS III manufactured by Thermo Scientific. The measurement temperature is set to 25° C.

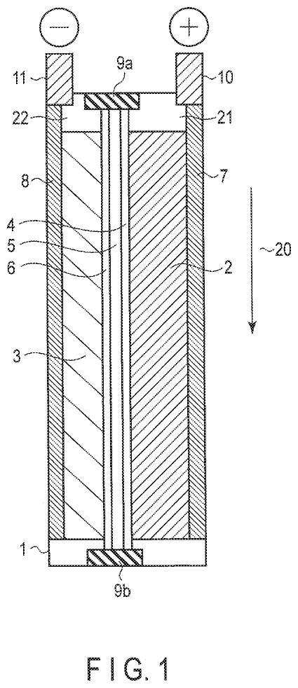

An example of the secondary battery is shown in FIG. 1. FIG. 1 shows a cross section of the secondary battery taken along a first direction 20. The secondary battery includes a container member 1, an electrode group housed in the container member 1, a positive electrode terminal 10, and a negative electrode terminal 11. The positive electrode terminal 10 and the negative electrode terminal 11 are formed of a conductive material such as Cu or a Cu alloy. The container member 1 includes a rectangular cylindrical container provided with a bottom plate on one side, and a lid plate. The opposite side of the bottom plate of the container serves as an opening, and the lid plate is fixed to the opening by, for example, welding or swaging. The electrode group includes a positive electrode active material-containing layer 2, a negative electrode active material-containing layer 3, a first porous layer 4, a lithium-ion conductive separator 5, and a second porous layer 6, a positive electrode current collector 7, and a negative electrode current collector 8. For example, a non-woven fabric and a porous film may be used for the first porous layer 4 and the second porous layer 6, respectively. The first porous layer 4 and the second porous layer 6 may also use a separator not having lithium-ionic conductivity. The first porous layer 4 and the second porous layer 6 may be different kinds of separators or the same kind of separator. The positive electrode current collector 7 and the negative electrode current collector 8 are formed of a conductive material such as Cu or a Cu alloy. The positive electrode active material-containing layer 2 and the negative electrode active material-containing layer 3 are stacked so as to face each other with the first porous layer 4, the lithium-ion conductive separator 5 and the second porous layer 6 interposed therebetween. The first direction 20 is a direction orthogonal to the stacking direction. The first porous layer 4 holds or is impregnated with a liquid nonaqueous electrolyte. The first porous layer 4 is in contact with one of the surfaces (e.g., one of the surfaces or principal surfaces intersecting the thickness direction) of the positive electrode active material-containing layer 2. The positive electrode current collector 7 is in contact with the other surface of the positive electrode active material-containing layer 2. The second porous layer 6 holds or is impregnated with a liquid nonaqueous electrolyte. The second porous layer 6 is in contact with one of the surfaces (e.g., one of the surfaces or principal surfaces intersecting the thickness direction) of the negative electrode active material-containing layer 3. The negative electrode current collector 8 is in contact with the other surface of the negative electrode active material-containing layer 3. Both ends of the first porous layer 4, the lithium-ion conductive separator 5, and the second porous layer 6 in the first direction 20 protrude further than the positive electrode active material-containing layer 2 and the negative electrode active material-containing layer 3. An insulating support 9a is disposed between one end of each of the first porous layer 4, the lithium-ion conductive separator 5, and the second porous layer 6 in the first direction 20, and the back surface of the lid plate. In addition, an insulating support 9b is disposed between the other end in the first direction 20 and the bottom surface. The lithium-ion conductive separator 5 is a film which is selectively permeable to lithium ions and which is free from holes or has a non-communicating structure. The inside of the container member 1 is partitioned into two spaces by the lithium-ion conductive separator 5, so that there exist a space (positive electrode space) 21 defined by the separator 5, the insulating supports 9a and 9b, and the container member, and a space (negative electrode space) 22 defined by the separator 5, the insulating supports 9a and 9b, and the container member. The nonaqueous electrolyte in the positive electrode space 21 and the nonaqueous electrolyte in the negative electrode space 22 do not cross or mix with each other, and exist independently of each other.

The positive electrode terminal 10 and the negative electrode terminal 11 are provided on the lid plate with an insulating member (not shown) interposed therebetween. The positive electrode terminal 10 functions as an external positive electrode terminal, and the negative electrode terminal 11 functions as an external negative electrode terminal. The positive electrode current collector 7 is electrically connected to the positive electrode active material-containing layer 2 and the positive electrode terminal 10. On the other hand, the negative electrode current collector 8 is electrically connected to the negative electrode active material-containing layer 3 and the negative electrode terminal 11.

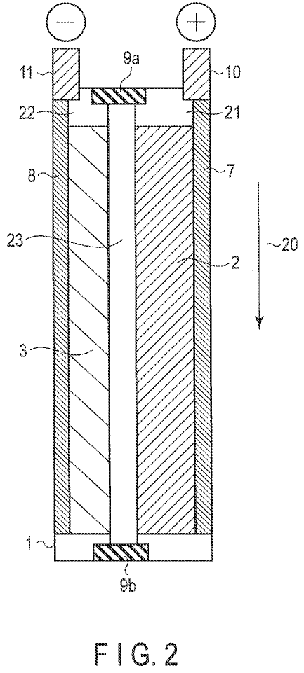

According to the secondary battery having the structure shown in FIG. 1, the lithium-ion conductive separator 5 can function as a partition wall, and thus can prevent the nonaqueous electrolyte of the positive electrode and the nonaqueous electrolyte of the negative electrode from crossing or mixing with each other. It suffices that the secondary battery has a structure that allows for charge and discharge; thus, the structure of the secondary battery is not limited to the structure shown in FIG. 1. For example, a single-layer separator may be used instead of using a stack of the first porous layer 4, the lithium-ion conductive separator 5, and the second porous layer 6 as the separator. This example is shown in FIG. 2. The separator 23 is disposed between the positive electrode active material-containing layer 2 and the negative electrode active material-containing layer 3. The insulating support 9a is disposed between one end of the separator 23 in the first direction 20 and the back surface of the lid plate. The insulating support 9b is disposed between the other end of the separator 23 in the first direction 20 and the bottom surface. For example, a porous layer is used for the separator 23. Examples of the porous layer include a non-woven fabric and a porous film.

The secondary battery according to the first embodiment described above includes a negative electrode, which includes one or more selected from the group consisting of lithium metal and a lithium alloy as a negative electrode active material, and a nonaqueous electrolytic solution, which contains an organic fluorine compound and an ionic liquid containing trialkyl sulfonium ions; therefore, the secondary battery according to the first embodiment can provide a secondary battery which has a high energy density and exhibits excellent high-temperature cycle performance and low-temperature performance. Moreover, the secondary battery, by virtue of its high energy density, is suitable for a stationary power supply and space applications.

### Second Embodiment

According to a second embodiment, a battery pack is provided. The battery pack includes the secondary battery according to the first embodiment. The battery pack may include one secondary battery according to the first embodiment or include a battery module constituted by multiple secondary batteries according to the first embodiment.

The battery pack according to the second embodiment may further include a protective circuit. The protective circuit has a function to control the charge and discharge of the secondary battery. Alternatively, a circuit included in equipment where the battery pack serves as a power source (for example, electronic devices, automobiles, and the like) may be used as the protective circuit of the battery pack.

Moreover, the battery pack according to the second embodiment may further include an external power distribution terminal. The external power distribution terminal is configured to externally output current from the secondary battery, and/or to input external current into the secondary battery. In other words, when the battery pack is used as a power source, the current is supplied to the outside through the external power distribution terminal. When the battery pack is charged, the charging current (including regenerative energy from the motive force of automobiles and the like) is supplied to the battery pack via the external power distribution terminal.

Next, an example of the battery pack according to the second embodiment will be described with reference to the drawings.

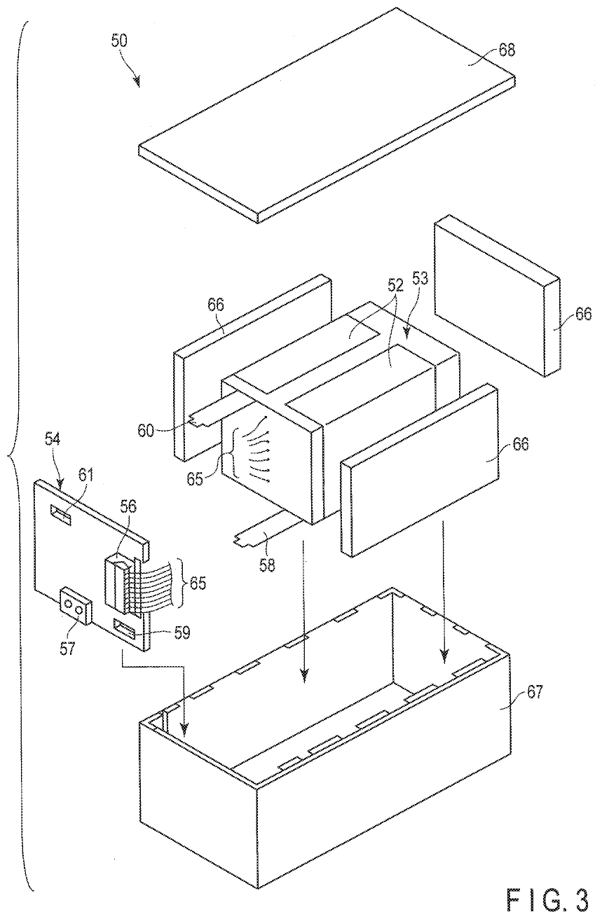

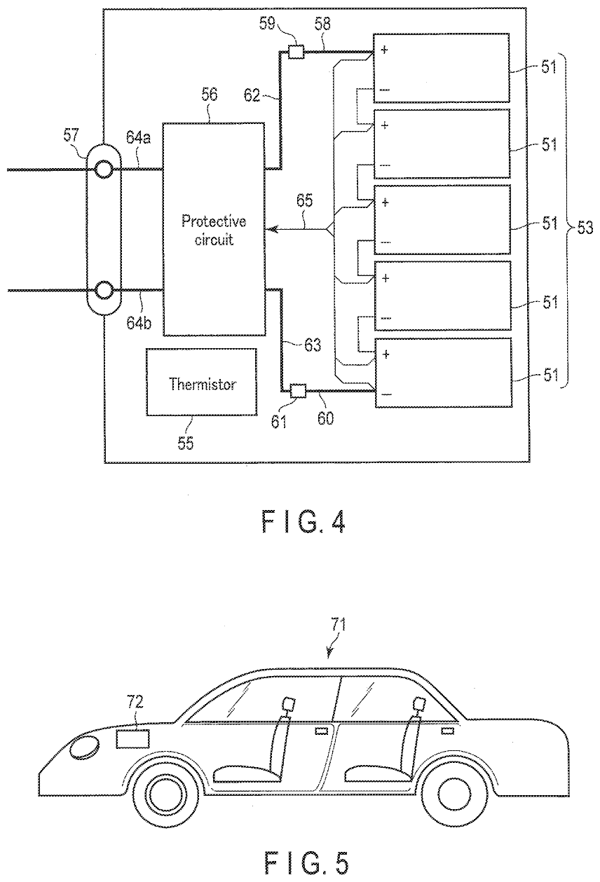

FIG. 3 is an exploded perspective view schematically showing an example of the battery pack according to the second embodiment that is disassembled for each part. FIG. 4 is a block diagram showing an example of an electric circuit of the battery pack shown in FIG. 3.

FIGS. 3 and 4 show an example of a battery pack 50. The battery pack 50 shown in FIGS. 3 and 4 includes multiple secondary batteries according to the embodiment. Multiple secondary batteries 51 are stacked so that the negative electrode terminals and the positive electrode terminals are aligned in the same direction and fastened with an adhesive tape 52 to constitute a battery module 53. These secondary batteries 51 are electrically connected to each other in series as shown in FIG. 4.

A printed wiring board 54 is arranged to face the plane of the secondary battery 51 where the negative electrode terminal and the positive electrode terminal are disposed. A thermistor 55, a protective circuit 56, and an external power distribution terminal 57 to an external device are mounted on the printed wiring board 54 as shown in FIG. 4. An insulating plate (not shown) is attached to the surface of the printed wiring board 54 facing the battery module 53 to avoid unnecessary connection with the wires of the battery module 53.

A positive electrode-side lead 58 is connected to the positive electrode terminal positioned at the bottom layer of the battery module 53, and the distal end of the lead 58 is inserted into a positive electrode-side connector 59 of the printed wiring board 54 so as to be electrically connected. A negative electrode-side lead 60 is connected to the negative electrode terminal positioned at the top layer of the battery module 53, and the distal end of the lead 60 is inserted into a negative electrode-side connector 61 of the printed wiring board 54 so as to be electrically connected. The connectors 59 and 61 are connected to the protective circuit 56 through wires 62 and 63 formed on the printed wiring board 54.

The thermistor 55 detects the temperature of the secondary batteries 51, and the detection signal is sent to the protective circuit 56. The protective circuit 56 can shut down a plus-side wire 64a and a minus-side wire 64b between the protective circuit 56 and the external power distribution terminal 57 to an external device under a predetermined condition. An example of the predetermined condition is a state in which the temperature detected by the thermistor 55 reaches a predetermined level or higher. Another example of the predetermined condition is a state in which overcharge, overdischarge, over-current, and the like of the secondary batteries 51 is detected. The detection of the overcharge and the like is performed either on individual secondary batteries 51 or the secondary batteries 51 in their entirety. When each of the secondary batteries 51 is to be detected, the battery voltage may be detected, or a positive electrode potential or a negative electrode potential may be detected. In the latter case, a lithium electrode to be used as a reference electrode is inserted into each of the secondary batteries 51. In the case of the battery pack shown in FIGS. 3 and 4, wires 65 for voltage detection are connected to each of the secondary batteries 51, and detection signals are sent to the protective circuit 56 through the wires 65.

Protective sheets 66 made of rubber or resin are arranged on three side surfaces of the battery module 53 except on the side surface from which the positive electrode terminal and the negative electrode terminal protrude.

The battery module 53 is housed in a housing container 67 together with each of the protective sheets 66 and the printed wiring board 54. That is, the protective sheets 66 are arranged on both inner side surfaces in the long-side direction and an inner side surface in the short-side direction of the housing container 67, and the printed wiring board 54 is disposed on the opposite inner side surface in the short-side direction. The battery module 53 is positioned in a space surrounded by the protective sheets 66 and the printed wiring board 54. A lid 68 is attached to the upper surface of the housing container 67.

In order to fix the battery module 53, a heat-shrinkable tape may be used in place of an adhesive tape 52. In this case, the battery module is bound by placing the protective sheets on the both sides of the battery module, winding the heat-shrinkable tape around the battery module, and then thermally shrinking the heat-shrinkable tape.

FIGS. 3 and 4 show the configuration in which the secondary batteries 51 are connected in series; however, the secondary batteries may be connected in parallel to increase the battery capacity. Alternatively, the batteries may be connected in a combination of in series and in parallel. The assembled battery pack can also be connected in series or in parallel.

The battery pack shown in FIGS. 3 and 4 includes a single battery module; however, the battery pack according to the embodiment may include multiple battery modules. The multiple battery modules are electrically connected in series, in parallel, or in a combination of series connection and parallel connection.

The aspect of the battery pack can be appropriately changed depending on the applications. The battery pack according to the present embodiment is suitably used in applications where excellent cycle performance is demanded during extraction of a large current. More specifically, the battery pack is used as a power supply for a digital camera, a battery for a vehicle such as a two- or four-wheeled hybrid electric automobile, a two- or four-wheeled electric automobile, an electric assist bicycle, or a railway vehicle (for example, an electric train), or a stationary battery. In particular, the battery pack is suitably used as a large-sized storage battery for a stationary power storage system or an in-vehicle battery for vehicles.

The battery pack according to the second embodiment includes the secondary battery according to the first embodiment. Therefore, the battery pack according to the second embodiment has a high energy density and is excellent in high-temperature cycle performance and low-temperature performance.

### Third Embodiment

According to a third embodiment, a vehicle is provided. The vehicle includes the battery pack according to the second embodiment.

In the vehicle according to the third embodiment, the battery pack is configured, for example, to recover regenerative energy from the motive force of the vehicle. The vehicle may include a mechanism configured to convert kinetic vehicular energy into regenerative energy.

Examples of the vehicle include two- to four-wheeled hybrid electric automobiles, two- to four-wheeled electric automobiles, electric assist bicycles, and railway cars.

The installation position of the battery pack in the vehicle is not particularly limited. For example, when installing the battery pack in an automobile, the battery pack can be installed in the engine compartment of the vehicle, in a rear part of the vehicle body, or under seats.

The vehicle may include multiple battery packs. In this case, the battery packs may be electrically connected in series, electrically connected in parallel, or electrically connected in a combination of in-series and in-parallel connections.

Next, an example of the vehicle according to the third embodiment will be described with reference to the drawings.

FIG. 5 is a cross-sectional view schematically showing an example of the vehicle according to the third embodiment.

The vehicle 71 shown in FIG. 5 includes a vehicle body and the battery pack 72 according to the second embodiment. In the example shown in FIG. 5, the vehicle 71 is a four-wheeled automobile.

The vehicle 71 may include multiple battery packs 72. In this case, the battery packs 72 may be connected in series, in parallel, or in a combination of in-series and in-parallel connections.

In FIG. 5, the battery pack 72 is installed in an engine compartment located at the front of the vehicle body. As described above, the battery pack 72 may be installed in a rear part of the vehicle body, or under seats. The battery pack 72 may be used as a power source of the vehicle. In addition, the battery pack 72 can recover regenerative energy from the motive force from the vehicle.

The vehicle according to the third embodiment includes the battery pack according to the second embodiment. Thus, the present embodiment can provide a vehicle that includes a battery pack having a high energy density and being excellent in high-temperature cycle performance and low-temperature performance.

### Fourth Embodiment

According to a fourth embodiment, a stationary power supply is provided. The stationary power supply includes the battery pack according to the second embodiment. The stationary power supply may include the secondary battery or battery module according to the first embodiment, instead of the battery pack according to the second embodiment.

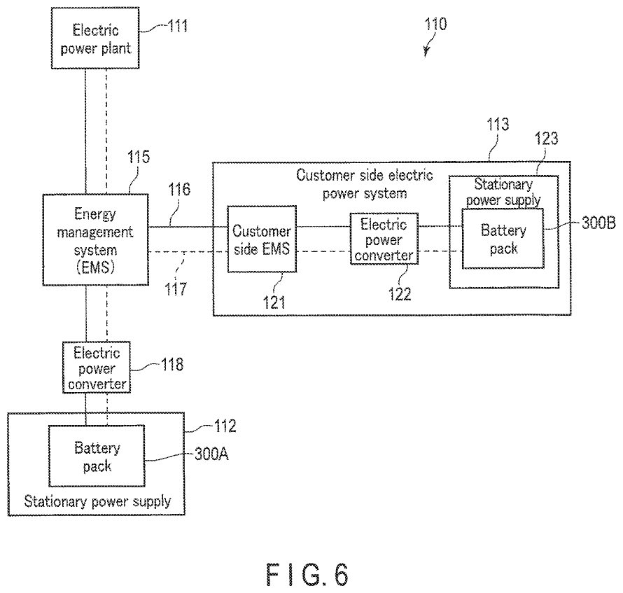

FIG. 6 is a block diagram showing an example of a system including a stationary power supply according to the fourth embodiment. FIG. 6 is a diagram showing an application example to stationary power supplies 112, 123 as an example for use of the battery packs 300A, 300B according to the second embodiment. In the example shown in FIG. 6, a system 110 in which the stationary power supplies 112, 123 are used is shown. The system 110 includes an electric power plant 111, the stationary power supply 112, a customer side electric power system 113, and an energy management system (EMS) 115. Also, an electric power network 116 and a communication network 117 are formed in the system 110, and the electric power plant 111, the stationary power supply 112, the customer side electric power system 113 and the EMS 115 are connected via the electric power network 116 and the communication network 117. The EMS 115 performs control operations to stabilize the entire system 110 by utilizing the electric power network 116 and the communication network 117.

The electric power plant 111 generates a large amount of electric power from fuel sources such as thermal power or nuclear power. Electric power is supplied from the electric power plant 111 through the electric power network 116 and the like. In addition, the battery pack 300A is installed in the stationary power supply 112. The battery pack 300A can store electric power and the like supplied from the electric power plant 111. In addition, the stationary power supply 112 can supply the electric power stored in the battery pack 300A through the electric power network 116 and the like. The system 110 is provided with an electric power converter 118. The electric power converter 118 includes a converter, an inverter, a transformer and the like. Thus, the electric power converter 118 can perform conversion between direct current and alternate current, conversion between alternate currents of frequencies different from each other, voltage transformation (step-up and step-down) and the like. Therefore, the electric power converter 118 can convert electric power from the electric power plant 111 into electric power that can be stored in the battery pack 300A.

The customer side electric power system 113 includes an electric power system for factories, an electric power system for buildings, an electric power system for home use and the like. The customer side electric power system 113 includes a customer side EMS 121, an electric power converter 122, and the stationary power supply 123. The battery pack 300B is installed in the stationary power supply 123. The customer side EMS 121 performs control operations to stabilize the customer side electric power system 113.

Electric power from the electric power plant 111 and electric power from the battery pack 300A are supplied to the customer side electric power system 113 through the electric power network 116. The battery pack 300B can store electric power supplied to the customer side electric power system 113. Similarly to the electric power converter 118, the electric power converter 122 includes a converter, an inverter, a transformer and the like. Thus, the electric power converter 122 can perform conversion between direct current and alternate current, conversion between alternate currents of frequencies different from each other, voltage transformation (step-up and step-down) and the like. Therefore, the electric power converter 122 can convert electric power supplied to the customer side electric power system 113 into electric power that can be stored in the battery pack 300B.

The electric power stored in the battery pack 300B can be used, for example, for charging a vehicle such as an electric car. Also, the system 110 may be provided with a natural energy source. In such a case, the natural energy source generates electric power through natural energy such as wind power and solar light. In addition to the electric power plant 111, electric power is also supplied from the natural energy source through the electric power network 116.

The stationary power supply according to the fourth embodiment includes the battery pack according to the second embodiment. Thus, the present embodiment can provide a stationary power supply that includes a battery pack having a high energy density and being excellent in high-temperature cycle performance and low-temperature performance.

### Fifth Embodiment

According to a fifth embodiment, a nonaqueous electrolyte including an ionic liquid which is, in effect, composed of a cation and an anion is provided. The cation essentially or substantially consists of trialkyl sulfonium ions and lithium ions. The anion essentially or substantially consists of a first anion of [N(FSO₂)₂]⁻, and a second anion essentially or substantially consisting of one or more selected from the group consisting of [N(CF₃SO₂)₂]⁻, [N(FSO₂)(CF₃SO₂)]⁻, [N(FSO₂)(C₂F₅SO₂)]⁻, [N(FSO₂)(n-C₄F₉SO₂)]⁻, PF₆⁻ and BF₄⁻. A molar ratio between the first anion and the second anion is in the range of 1:4 to 4:1. A molar ratio between the lithium ions and the trialkyl sulfonium ions is in the range of 1:4 to 4:1. Herein, [N(FSO₂)₂]⁻ is referred to as FSI⁻; [N(CF₃SO₂)₂]⁻ is referred to as TFSI⁻; [N(FSO₂)(CF₃SO₂)]⁻ is referred to as FTFSI⁻; [N(FSO₂)(C₂F₅SO₂)]⁻ is referred to as FPFSI⁻; and [N(FSO₂)(n-C₄F₉SO₂)]⁻ is referred to as FNFSI⁻.

The nonaqueous electrolyte of the embodiment is a liquid. The ionic liquid having the above composition includes one or more kinds of salts. Herein, the molar ratio is calculated from a weight molar concentration (mol/kg) of the salt included in the ionic liquid. The volume and the specific weight of the ionic liquid may vary depending on the temperature, but the dependency of the weight of the ionic liquid on the temperature is low. Thus, the nonaqueous electrolyte according to the embodiment can show a fixed composition over a wide temperature range.

In general, when the concentration of Li ions in the ionic liquid is increased, the melting point of the ionic liquid is increased, so that the ionic liquid shows a solid state in the operating temperature range. Namely, the concentration of Li ions in the ionic liquid and the melting point of the ionic liquid are in a trade-off relationship. As a result of conducting intensive research, the inventors have found for the first time that according to the nonaqueous electrolyte having the above composition, even if the Li-ion concentration is increased to approximately 3 mol/kg, for example, a liquid state is maintained at a low melting point and over a wide temperature range. The nonaqueous electrolyte of the embodiment can stably maintain the supercooled state even in a low temperature of −50° C. or less without being solidified or crystallized. This is assumed to be because the difference between the size of the first anion and the size of the second anion causes structural disorder of the nonaqueous electrolyte and can suppress crystallization of the nonaqueous electrolyte in a low temperature. The nonaqueous electrolyte of the embodiment can maintain the liquid state over a wide temperature range from a high temperature (e.g., 200° C.) to a low temperature (e.g., −50° C. or less), and exhibit ionic conductivity. Also, the nonaqueous electrolyte of the embodiment can possess stableness, non-volatility and ionic conductivity from a low temperature to a high temperature. Thus, the nonaqueous electrolyte of the embodiment can be used as a nonaqueous electrolyte of power storage devices (such as a secondary battery and a capacitor) for automobiles, industrial applications and space applications. Also, with the advantage of the characteristic of possessing stable non-volatile ionic conductivity from a low temperature to a high temperature, the nonaqueous electrolyte of the embodiment can be applied to, for example, a medium for material synthesis, an actuator, and an electrolyte for a sensitizing solar cell. A more preferred molar ratio between the first anion and the second anion is in the range of 1:3 to 2:1. A more preferred molar ratio between the lithium ions and the trialkyl sulfonium ions is in the range of 1:3 to 2:1. The viscosity of the ionic liquid can be decreased by setting the molar ratio between the first anion and the second anion in a range of 1:3 to 2:1, setting the molar ratio between the lithium ions and the trialkyl sulfonium ions in a range of 1:3 to 2:1, or satisfying both of them. As a result, the charge transfer resistance at the negative electrode interface can be decreased, leading to improved discharge performance and cycle life performance of the secondary battery. It is most preferable to satisfy both of the molar ratios described above.

The nonaqueous electrolyte may be shared by the positive electrode and the negative electrode. In this case, it is preferable that the nonaqueous electrolyte be in contact with at least one of the positive electrode or the negative electrode, or be included or held in at least one of the positive electrode, the negative electrode, or the separator, thereby enabling a charge-discharge reaction to occur smoothly.

The first anion (FSI⁻) is present in the ionic liquid obtained by mixing a lithium salt (LiFSI) of the first anion and a second organic salt made of the second anion and trialkyl sulfonium ions.

The second anion is not deposited when forming a salt with a cation such as Li ions, and may exist in a liquid state. Among the second anions, TFSI⁻ and FTFSI⁻ are preferred.

Trialkyl sulfonium ions have a framework shown in Chemical Formula 1, and are paired with anions. Trialkyl sulfonium ions are trimethylsulfonium ions (S(CH₃)₃⁺: abbreviated S111), triethylsulfonium ions (S(C₂H₅)₃⁺: abbreviated S222), diethylpropylsulfonium ions (S(C₂H₅)₂(C₃H₇)⁺: abbreviated S223), and methylethylpropylsulfonium ions (S(CH₃)(C₂H₅)(C₃H₇)⁺: abbreviated S123). Triethylsulfonium ions (S222) and methylethylpropylsulfonium ions (S123) are preferred. This is because having the respective cations contained in the ionic liquid decreases the melting point of the ionic liquid and increases ionic conductivity. One, or two or more kinds of trialkyl sulfonium ions can be used.

The nonaqueous electrolyte may contain an organic fluorine compound. Thereby, a coating for suppressing reductive decomposition of the ionic liquid can be formed at the negative electrode interface. The organic fluorine compound is, for example, one or more selected from the group consisting of fluorinated ester and fluorinated ether. The fluorinated ester includes fluoroethylene carbonate (FEC), difluoroethylene carbonate (DFEC), and 2,2,2-trifluoroethylmethylcarbonate (TFEMC). On the other hand, as the fluorinated ether, 1,1,2,2-tetrafluoro-2,2,2-trifluoroethylether (HFE) can be cited. One, or two or more kinds of organic fluorine compounds can be employed. The content of the organic fluorine compound in the nonaqueous electrolyte can be set in a range of 0.1% by weight to 10% by weight. Thereby, the reaction for forming a coating for suppressing reductive decomposition of the ionic liquid at the negative electrode interface can be promoted, leading to a reduction of the negative electrode interface resistance. Accordingly, the cycle life performance and the discharge rate performance of the secondary battery can be improved. The content is more preferably from 0.5% by weight to 5% by weight.

The concentration of Li ions in the nonaqueous electrolyte can be set in a range of 0.5 mol/kg to 3 mol/kg.

A method of identifying the components of the nonaqueous electrolyte is as described in the first embodiment.

According to the nonaqueous electrolyte of the fifth embodiment described above, the molar ratio between the first anion and the second anion is set in a range of 1:4 to 4:1, and the molar ratio between the lithium ions and the trialkyl sulfonium ions is set in a range of 1:4 to 4:1. Thus, a nonaqueous electrolyte can be provided which can maintain the liquid state over a wide temperature range from a high temperature (e.g., 200° C.) to a low temperature (e.g., −50° C. or less) and exhibit ionic conductivity over the wide temperature range.

### Sixth Embodiment

According to a sixth embodiment, a secondary battery including a positive electrode, a negative electrode, and a nonaqueous electrolyte is provided. The nonaqueous electrolyte of the fifth embodiment is used as the nonaqueous electrolyte. The same positive electrode and negative electrode as those described in the first embodiment may be used. The secondary battery may further include a separator and a container member. The same separator and container member as those described in the first embodiment may be used. The configuration described in the first embodiment can be combined with the secondary battery according to the sixth embodiment.

Other than the positive and negative electrodes described above, a positive electrode and a negative electrode described below can be used as the positive electrode and the negative electrode of the secondary battery of the sixth embodiment.

Positive Electrode

The positive electrode includes: a positive electrode active material-containing layer including a positive electrode active material; and a positive electrode current collector in contact with the positive electrode active material-containing layer.

For the positive electrode active material, a lithium metal oxide which allows lithium ions to be inserted and extracted may be used. Examples of the lithium metal oxide may be the same as those described in the first embodiment. The positive electrode which includes such a positive electrode active material can realize a high voltage of 3.5 V or more, for example. One, or two or more kinds of positive electrode active materials may be used.

The positive electrode active material-containing layer may include an electro-conductive agent. Examples of the electro-conductive agent may be the same as those described in the first embodiment. One, or two or more kinds of electro-conductive agents may be used. The proportion of the electro-conductive agent in the positive electrode active material-containing layer (excluding the weight of the nonaqueous electrolyte) is preferably from 5% by weight to 40% by weight.

The positive electrode active material-containing layer may include a binder. Examples of the binder may be the same as those described in the first embodiment. The proportion of the binder in the positive electrode active material-containing layer (excluding the weight of the nonaqueous electrolyte) is preferably from 1% by weight to 10% by weight.

For example, a porous material, mesh or foil made of aluminum or aluminum alloy can be used as the positive electrode current collector. The thickness of the positive electrode current collector is preferably from 10 μm to 20 μm. The porosity of the porous material is preferably from 30% to 98%. The porosity of the porous material is more preferably from 50% to 60%.

The thickness of the positive electrode varies depending on the shapes and applications of the electrode. When the electrode group takes a stacked structure or a wound structure, the thickness of the positive electrode is preferably from 30 μm to 100 μm in a high-output application, and from 100 μm to 500 μm in a high-energy application.

Negative Electrode

The negative electrode includes a negative electrode active material capable of having lithium or lithium ions inserted and extracted. The negative electrode active material may be one or more selected from the group consisting of lithium metal, a lithium alloy, and a compound capable of having Li inserted and extracted. One, or two or more kinds of negative electrode active materials may be used.

The compound capable of having Li inserted and extracted is a compound capable of having lithium or lithium ions inserted and extracted. Examples of the compound include graphite and a carbon material.

Examples of the lithium alloy include alloys such as Li—Al, Li—Si, Li—Zn, and Li—Mg. A more preferred alloy is Li—Mg alloy which suppresses Li dendrite deposition. The content molar ratio of Mg is preferably in the range of 0.05 to 0.15.

The lithium metal and the lithium alloy are preferably in the form of a foil.

The negative electrode may include a negative electrode active material-containing layer. The negative electrode active material-containing layer may contain an electro-conductive agent and/or a binder.

For example, a carbon material, a metal compound powder, a metal powder, or the like can be used as the electro-conductive agent. Examples of the carbon material include acetylene black, carbon black, coke, carbon fibers, graphite, and carbon nanotubes. The BET specific surface area by N₂ adsorption of the carbon material is preferably 10 m²/g or more. Examples of the metal compound powder include powders of TiO, TiC, and TiN. Examples of the metal powder include powders of Al, Ni, Cu, and Fe. Preferred examples of the electro-conductive agent include coke having an average particle diameter of 10 μm or less with a heat treatment temperature of 800° C. to 2000° C., graphite, acetylene black, carbon fibers having an average fiber diameter of 1 μm or less, and TiO powder. When one or more selected from these are used, the electrode resistance can be reduced and the cycle life performance can be improved. One, or two or more kinds of electro-conductive agents may be used.

Examples of the binder include polytetrafluoroethylene (PTFE), polyvinylidene fluoride (PVdF), fluorine-based rubber, acrylic rubber, styrene-butadiene rubber, a core-shell binder, polyimide, and carboxymethyl cellulose (CMC). The kinds of the binder used may be one, two, or more.

The negative electrode active material-containing layer containing a compound capable of having Li inserted and extracted (hereinafter, referred to as a “first compound”) is produced by, for example, suspending the first compound, the electro-conductive agent, and the binder in an appropriate solvent, applying the suspension to a current collector, drying the suspension, and performing pressing. The mixing ratio of the first compound, the electro-conductive agent, and the binder is preferably 80% to 95% by weight of the first compound, 3% to 18% by weight of the electro-conductive agent, and 2% to 7% by weight of the binder. A lithium metal foil or a lithium alloy foil may be used as the negative electrode active material-containing layer.

The negative electrode may further include a negative electrode current collector. Examples of the negative electrode current collector include a foil or mesh including a metal such as copper or nickel. The negative electrode current collector may be in contact with the negative electrode active material-containing layer. The negative electrode current collector is preferably electrically connected to a negative electrode terminal via a lead.

The thickness of the negative electrode varies depending on the shapes and applications of the electrode. When the electrode group takes a stacked structure or a wound structure, the thickness of the negative electrode is preferably 30 μm to 100 μm in a high-output application, and 100 μm to 500 μm in a high-energy application.

When one or more selected from the group consisting of lithium metal, a lithium alloy, and a compound capable of having Li inserted and extracted, as a negative electrode active material(s), is(are) to be contained in the negative electrode, having the nonaqueous electrolyte of the fifth embodiment contain an organic fluorine compound enables formation of a coating for suppressing reductive decomposition of the ionic liquid at the negative electrode interface. As a result, the negative electrode interface resistance can be reduced, leading to improved cycle life performance and discharge rate performance. Also, when the positive electrode having a high voltage of 3.5 V or more is combined with the negative electrode and the nonaqueous electrolyte, overvoltage at the positive electrode can be decreased, and thus improvement of the cycle life can be expected. A lithium secondary battery which includes a negative electrode including one or more selected from the group consisting of lithium metal, a lithium alloy, and a compound capable of having Li inserted and extracted as a negative electrode active material(s), and a positive electrode including a high-voltage metal oxide capable of having Li inserted and extracted as a positive electrode active material can realize a high-energy density, excellent cycle performance, discharge rate performance, and low-temperature performance over a wide temperature range.

Since the secondary battery of the sixth embodiment described above includes the nonaqueous electrolyte of the fifth embodiment, a secondary battery having a high energy density and exhibiting excellent cycle performance, discharge rate performance and low-temperature performance over a wide temperature range can be provided.

The secondary battery of the sixth embodiment can be used for a battery pack, a vehicle, or a stationary power supply. The embodiments of the battery pack, vehicle, and stationary power supply are as described in the second to fourth embodiments.

### EXAMPLES

Hereinafter, Examples of the present invention will be described in detail with reference to the accompanying drawings; however, the present invention is not limited to the Examples described below.

### Example 1

As a positive electrode active material, copper (II) chloride (CuCl₂) was provided. A positive electrode active material-containing layer was produced with the positive electrode active material, acetylene black, graphite, and a polyethylene terephthalate binder contained in a weight ratio of 85:7:3:5. The positive electrode active material-containing layer was pressure-attached onto a copper mesh current collector having a thickness of 15 μm. The thickness of the stack obtained was 100 μm, and the density of the positive electrode active material-containing layer was 2 g/cm³. 0.6 mol/kg of LiTFSI and 0.05 mol/kg of LiCl were dissolved in S(C₂H₅)₃N(CF₃SO₂)₂ (abbreviated S222TFSI) of triethylsulfonium salt, to obtain an ionic liquid as a nonaqueous electrolyte to be brought into contact with the positive electrode. The ionic liquid was injected into the positive electrode active material-containing layer so that the content of the ionic liquid in the positive electrode active material-containing layer would be 40% by weight, to thereby produce a positive electrode. A first porous layer made of a cellulose non-woven fabric having a thickness of 10 μm was provided on the surface of the positive electrode active material-containing layer opposite to the surface thereof in contact with the positive electrode current collector, and an ionic liquid as a second liquid nonaqueous electrolyte was contained in the first porous layer.

A lithium metal foil having a thickness of 90 μm was pressure-attached onto a copper current collector foil having a thickness of 10 μm, to thereby produce a negative electrode. A second porous layer made of a cellulose non-woven fabric having a thickness of 10 μm was provided on the surface of the lithium metal of the negative electrode. As a nonaqueous electrolyte for the negative electrode, a liquid nonaqueous electrolyte was prepared by adding 10% by weight of FEC to S222TFSI of triethylsulfonium salt, and dissolving 0.6 mol/kg of LiTFSI therein. The nonaqueous electrolyte for the negative electrode as a first liquid nonaqueous electrolyte was contained in the second porous layer.

A lithium-ion conductive solid electrolyte plate was arranged as a separator between the first porous layer on the positive electrode and the second porous layer on the negative electrode, thereby obtaining an electrode group. As the lithium-ion conductive solid electrolyte plate, a plate-shaped Li_{1.3}Al_{0.3}Ti_{1.7}(PO₄)₃(LATP) having a thickness of 30 μm was used. This configuration can prevent contact between the ionic liquid in the positive electrode and the negative electrode lithium metal. The above electrode group was housed in a container made of an aluminum-containing laminated film having a thickness of 0.1 mm, thereby producing a thin secondary battery having the above-described structure shown in FIG. 1. The secondary battery had a size of 0.7 mm×160 mm×210 mm, a capacity of 2.7 Ah, an average voltage of 2.8 V, and a weight of 30 g.

### Example 2

As the positive electrode active material, lithium iron phosphate (LiFePO₄) particles of an olivine structure having an average primary particle size of 0.1 μm and having carbon fine particles (average particle size: 0.005 μm) adhered onto the surface thereof (adherence amount: 0.1% by weight) was used. 2% by weight of vapor-grown carbon fibers (VGCF) having a fiber diameter of 0.1 μm and 6% by weight of graphite powder as electro-conductive agents, and 5% by weight of PVdF as a binder were mixed with the positive electrode active material. The respective mixing amounts were based on the weight of the positive electrode active material-containing layer. These materials were dispersed in an n-methylpyrrolidone (NMP) solvent to prepare a slurry, which was then applied to a current collector made of an aluminum foil having a thickness of 10 μm, dried, and pressed, to thereby produce a positive electrode. The thickness of the positive electrode active material-containing layer was 100 μm, and the density of the positive electrode active material-containing layer was 2.0 g/cm³.

A lithium metal foil having a thickness of 50 μm was pressure-attached onto a copper current collector foil having a thickness of 10 μm to produce a negative electrode.

100 parts by weight of Al₂O₃ particles having an average particle size of 1 μm, and 4 parts by weight of polyvinylidene fluoride were dispersed in NMP to prepare a slurry. The slurry was applied onto both surfaces of a porous layer made of a cellulose non-woven fabric having a thickness of 30 μm and dried, to thereby form an alumina particle layer having a thickness of 3 μm on both surfaces of the porous layer and obtain a separator.

The separator thus obtained was arranged between the positive electrode and the negative electrode to obtain an electrode group. As a nonaqueous electrolyte, a liquid nonaqueous electrolyte was prepared by adding 10% by weight of FEC to S₂₂₂TFSI of triethylsulfonium salt, and dissolving 0.6 mol/kg of LiTFSI therein. The liquid nonaqueous electrolyte was contained in the separator. The above electrode group was housed in a container made of an aluminum-containing laminated film having a thickness of 0.1 mm, thereby producing a thin secondary battery having the above-described structure shown in FIG. 2. The secondary battery had a size of 0.6 mm×160 mm×210 mm, a capacity of 1.4 Ah, an average voltage of 3.4 V, and a weight of 28 g.

### Examples 3 to 15, 23 to 27

Secondary batteries including the same separator as that of the secondary battery of Example 2 were produced. Specifically, secondary batteries were produced in the same manner as described in Example 2, except that the positive electrode active materials, the compositions of the liquid nonaqueous electrolytes of the positive electrodes, the compositions of the liquid nonaqueous electrolytes of the negative electrodes, and the types of the negative electrodes were changed as shown in Tables 1 to 4.

When a positive electrode active material other than LiFePO₄ was used as the positive electrode active material, carbon fine particles were not provided on the surface of the positive electrode active material particles.

Liquid nonaqueous electrolytes having the same composition were used for the positive electrodes and the negative electrodes. The numerical values in parentheses of the lithium salts shown in Tables 3 and 4 represent the molar concentration (mol/kg) thereof in the liquid nonaqueous electrolyte.

The numerical values in parentheses of the organic fluorine compounds represent percentage by weight thereof in the liquid nonaqueous electrolyte.

A foil made of a Li_{0.9}Mg_{0.1} alloy and having a thickness of 50 μm was pressure-attached onto a current collector made of a copper foil and having a thickness of 10 μm to thereby produce negative electrodes as the negative electrodes of Examples 6 and 9.

### Examples 16 to 22

Secondary batteries including the same separator as that of the secondary battery of Example 1 was produced. Specifically, secondary batteries were produced in the same manner as described in Example 1, except that the positive electrode active materials, the compositions of the liquid nonaqueous electrolytes of the positive electrodes, the compositions of the liquid nonaqueous electrolytes of the negative electrodes, and the types of the negative electrodes were changed as shown in Tables 1 to 4.

### Comparative Examples 1 to 2

Secondary batteries including the same separator as that of the secondary battery of Example 1 was produced. Specifically, secondary batteries were produced in the same manner as described in Example 1, except that the positive electrode active materials, the compositions of the liquid nonaqueous electrolytes of the positive electrodes, the compositions of the liquid nonaqueous electrolytes of the negative electrodes, and the types of the negative electrodes were changed as shown in Tables 2 and 4. Neither of the secondary batteries used an organic fluorine compound. The nonaqueous electrolytic solution of Comparative Example 1 was composed of an ionic liquid. The nonaqueous electrolytic solution of Comparative Example 2 was prepared by dissolving 1 mol/kg of LiPF₆ in methyldifluoroacetate.

### Comparative Examples 3 to 10

Secondary batteries including the same separator as that of the secondary battery of Example 2 were produced. Specifically, secondary batteries were produced in the same manner as described in Example 2, except that the positive electrode active materials, the compositions of the liquid nonaqueous electrolytes of the positive electrodes, the compositions of the liquid nonaqueous electrolytes of the negative electrodes, and the types of the negative electrodes were changed as shown in Tables 2 and 4.

The nonaqueous electrolytic solutions of Comparative Example 3, 4, 7, and 8 were composed of an ionic liquid. EMI represents 1-ethyl-3-methylimidazolium. The nonaqueous electrolytic solution of Comparative Example 5 was prepared by dissolving 0.6 mol/kg of LiTFSI in an FEC solvent. The nonaqueous electrolytic solution of Comparative Example 6 was prepared by dissolving 1 M of LiPF₆ in ethylene carbonate. The electrolytic solution of Comparative Example 9 was prepared by adding 10% by weight of FEC to S222TFSI of triethylsulfonium salt, and dissolving 0.6 mol/kg of LiTFSI therein. A gel electrolytic solution of Comparative Example 10 was prepared by the following method. A SiO₂ nanofiber non-woven fabric was immersed into a mixed solvent made of N,N-dimethylformamide and water, followed by ultrasonic treatment, to prepare a SiO₂ nanofiber dispersion liquid. This dispersion liquid was dried at 160° C. to thereby obtain a gelatinizing agent made of SiO₂ nanofibers. 10% by weight of FEC was added to S₂₂₂TFSI of triethylsulfonium salt, and 0.6 mol/kg of LiTFSI was dissolved therein. Thereafter, 3% by weight of SiO₂ nanofibers were added thereto and the end product was agitated, thereby obtaining the gel electrolytic solution.

The negative electrodes of Comparative Examples 6 and 9 were produced by the following method. Graphite powder and polyvinylidene fluoride (PVdF) were mixed at a weight ratio of 90:10, and the resulting mixture was kneaded in the presence of an organic solvent (N-methylpyrrolidone) to prepare a slurry. The obtained slurry was applied to a copper foil having a thickness of 15 μm, dried, and pressed, to thereby obtain a negative electrode. Lithium was inserted into the obtained negative electrode before initial discharge was performed.

The discharge capacity, the average voltage, the energy, 60° C. cycle life, and 1 C discharge retention ratio at 0° C. of the secondary batteries of the Examples and the Comparative Examples obtained were measured by the following method.

The secondary batteries of Examples 1 and 18 to 22 and Comparative Examples 1 and 2 were start-with-discharge secondary batteries, for which discharge was performed first when used. The discharge capacity (Ah) for discharging with 0.5 A and at 30° C. to reach 1.5 V, the average voltage (V=Wh/Ah), and the energy (Wh) were measured. As a high-temperature charge-and-discharge cycling test, charge with a constant current of 0.5 A at 60° C. was performed to reach 3.6 V, and then discharge with 0.5 A was performed to reach 1.5 V, the charge and discharge were repeated to determine the number of cycles at which the capacity retention ratio became 80% as a cycle life count. The discharge capacity C1 when discharge was performed at a 1 C rate in a low-temperature environment of 0° C. and the discharge capacity C2 when discharge was performed at a 0.2 C rate in a low-temperature environment of 0° C. were measured to obtain a value of C1/C2 as a discharge capacity retention ratio with 1 C at 0° C.

The secondary batteries of Examples 2 to 8 and 23 to 26 and Comparative Examples 4 to 6 and 8 to 10 were start-with-charge secondary batteries, for which charge was performed first when used. After the respective secondary batteries were charged with a constant current of 0.5 A at 30° C. to reach 3.6 V, the discharge capacity (Ah) for discharging with 0.5 A to reach 1.5 V, the average voltage (V=Wh/Ah), and the energy (Wh) were measured. As a high-temperature charge-and-discharge cycling test, charge with a constant current of 0.5 A at 60° C. was performed to reach 3.6 V, and then discharge with 0.5 A was performed to reach 1.5 V, the charge and discharge were repeated to determine the number of cycles at which the capacity retention ratio became 80% as a cycle life count. The discharge capacity C1 when discharge was performed at a 1 C rate in a low-temperature environment of 0° C. and the discharge capacity C2 when discharge was performed at a 0.2 C rate in a low-temperature environment of 0° C. were measured to obtain a value of C1/C2 as a discharge capacity retention ratio with 1 C at 0° C.

The secondary batteries of Examples 10 to 17 and Comparative Example 3 were start-with-discharge secondary batteries, for which discharge was performed first when used. The discharge capacity (Ah) for discharging with 0.5 A and at 30° C. to reach 1.5 V, the average voltage (V=Wh/Ah), and the energy (Wh) were measured. As a high-temperature charge-and-discharge cycling test, charge with a constant current of 0.5 A at 60° C. was performed to reach 2.5 V, and then discharge with 0.5 A was performed to reach 1.5 V, the charge and discharge were repeated to determine the number of cycles at which the capacity retention ratio became 80% as a cycle life count. The capacity retention ratio when discharge was performed at a 1 C rate in a low-temperature environment of 0° C. was determined based on the aforementioned 0.2 C capacity.

The secondary batteries of Examples 9 and 27 and Comparative Example 7 were start-with-charge secondary batteries, for which charge was performed first when used. After the respective secondary batteries were charged with a constant current of 0.5 A at 30° C. to reach 4.2 V, the discharge capacity (Ah) for discharging with 0.5 A to reach 2.7 V, the average voltage (V=Wh/Ah), and the energy (Wh) were measured. As a high-temperature charge-and-discharge cycling test, charge with a constant current of 0.5 A at 60° C. was performed to reach 4.2 V, and then discharge with 0.5 A was performed to reach 2.7 V, the charge and discharge were repeated to determine the number of cycles at which the capacity retention ratio became 80% as a cycle life count. The capacity retention ratio when discharge was performed at a 1 C rate in a low-temperature environment of 0° C. was determined based on the 0.2 C capacity.

The results of the measurement are shown in Tables 5 and 6 below.

TABLE 1

| | Positive Electrode | Negative |
|---|---|---|
| | Active Material | Electrode |
| Example 1 | CuCl₂ | Li |
| Example 2 | LiFePO₄ | Li |
| Example 3 | LiFePO₄ | Li |
| Example 4 | LiFePO₄ | Li |
| Example 5 | LiFePO₄ | Li |
| Example 6 | LiFePO₄ | Li_{0.9}Mg_{0.1} Alloy |
| Example 7 | LiFePO₄ | Li |
| Example 8 | LiFePO₄ | Li |
| Example 9 | LiNi_{0.8}Co_{0.1}Mn_{0.1}O₂ | Li_{0.9}Mg_{0.1} Alloy |
| Example 10 | TiNb₂O₇ | Td |
| Example 11 | TiNb₂O₇ | Li |
| Example 12 | TiNb₂O₇ | Li |
| Example 13 | TiNb₂O₇ | Li |
| Example 14 | TiS₂ | Li |
| Example 15 | Li₄Ti₅O₁₂ | Li |
| Example 16 | CuS | Li |
| Example 17 | FeS | Li |
| Example 18 | CuF₂ | Li |
| Example 19 | CuCl₂ | Li |

TABLE 2

| | Positive Electrode | Negative |
|---|---|---|
| | Active Material | Electrode |
| Example 20 | CuCl₂ | Li |
| Example 21 | CuCl₂ | Li |
| Example 22 | CuCl₂ | Li |
| Example 23 | LiFePO₄ | Li |
| Example 24 | LiFePO₄ | Li |
| Example 25 | LiFePO₄ | Li |
| Example 26 | LiFePO₄ | Li |
| Example 27 | LiNi_{0.8}Co_{0.1}Mn_{0.1}O₂ | Li |
| Comparative Example 1 | CuCl₂ | Li |
| Comparative Example 2 | CuCl₂ | Li |
| Comparative Example 3 | TiNb₂O₇ | Li |
| Comparative Example 4 | LiFePO₄ | Li |
| Comparative Example 5 | LiFePO₄ | Li |
| Comparative Example 6 | LiFePO₄ | Graphite |
| Comparative Example 7 | LiNi_{0.8}Co_{0.1}Mn_{0.1}O₂ | Li |
| Comparative Example 8 | LiFePO₄ | Li |
| Comparative Example 9 | LiFePO₄ | Graphite |
| Comparative Example 10 | LiFePO₄ | Li |

TABLE 3

| | Positive Electrode | Negative Electrode |
|---|---|---|
| | Composition of | Composition of |
| | Nonaqueous Electrolyte | Nonaqueous Electrolyte |
| Example 1 | S222TFSI—LiTFSI (0.6 mol/kg) + | S222TFSI—LiTFSI (0.6 mol/kg) + FEC (10 wt %) |
| | LiCl (0.05 mol/kg) | |
| Example 2 | Same as Negative Electrode | S222TFSI—LiTFSI (0.6 mol/kg) + FEC (10 wt %) |
| Example 3 | Same as Negative Electrode | S222TFSI—LiTFSI (0.8 mol/kg) + FEC (10 wt %) |
| Example 4 | Same as Negative Electrode | S222TFSI—LiTFSI (1.2 mol/kg) + FEC (20 wt %) |
| Example 5 | Same as Negative Electrode | S222TFSI—LiTFSI (2.0 mol/kg) + FEC (30 wt %) |
| Example 6 | Same as Negative Electrode | S222FSI—LiFSI (0.3 mol/kg) + DFEC (0.5 wt %) |
| Example 7 | Same as Negative Electrode | S222FSI—LiFSI (0.6 mol/kg) + TFEMC (5 wt %) |
| Example 8 | Same as Negative Electrode | S222FSI—LiFSI (0.6 mol/kg) + HFE (5 wt %) |
| Example 9 | Same as Negative Electrode | S222FSI—LiFSI (0.9 |
| | | mol/kg) + LiPF₆ (0.1 mol/kg) + FEC (10 wt %) |
| Example 10 | Same as Negative Electrode | S222TFSI—LiTFSI (0.8 mol/kg) + FEC (10 wt %) |
| Example 11 | Same as Negative Electrode | S222FSI—LiTFSI (0.8 mol/kg) + FEC (10 wt %) |
| Example 12 | Same as Negative Electrode | S222TFSI—LiTFSI (0.6 mol/kg) + FEMC (10 wt %) |
| Example 13 | Same as Negative Electrode | S222TFSI—LiTFSI (0.6 mol/kg) + HFE (10 wt %) |
| Example 14 | Same as Negative Electrode | S222BF₄—LiBF₄ (0.6 mol/kg) + FEC (10 wt %) |
| Example 15 | Same as Negative Electrode | S222TFSI—LiTFSI (0.6 mol/kg) + FEC (10 wt %) |
| Example 16 | S222FSI—LiFSI (0.6 mol/kg) | S222FSI—LiFSI (0.6 mol/kg) + HFE (10 wt %) |
| Example 17 | S222FSI—LiFSI (0.6 mol/kg) | S222FSI—LiFSI (0.6 mol/kg) + HFE (10 wt %) |
| Example 18 | S222PF₆—LiPF₆ (0.6 mol/kg) | S222PF₆—LiPF₆ (0.6 mol/kg) + FEC (10 wt %) |
| Example 19 | S222TFSI—LiTFSI (0.6 mol/kg) + | S222TFSI—LiTFSI (0.6 mol/kg) + FEC (10 wt %) |
| | LiCl (0.05 mol/kg) | |

TABLE 4

| | Positive Electrode | Negative Electrode |
|---|---|---|
| | Composition of | Composition of |
| | Nonaqueous Electrolyte | Nonaqueous Electrolyte |
| Example 20 | S222TFSI—LiTFSI (0.6 mol/kg) + | S222TFSI—LiTFSI (0.6 mol/kg) + FEC (30 wt %) |
| | LiCl (0.05 mol/kg) | |
| Example 21 | S111TFSI—LiTFSI (0.6 mol/kg) + | S111TFSI—LiTFSI (0.6 mol/kg) + FEC (15 wt %) |
| | LiCl (0.05 mol/kg) | |
| Example 22 | S123TFSI—LiTPSI (0.6 mol/kg) + | S123TFSI—LiTFSI (0.6 mol/kg) + FEC (20 wt %) |
| | LiCl (0.05 mol/kg) | |
| Example 23 | Same as Negative Electrode | S222FTFSI—LiFTFSI (0.8 mol/kg) + FEC (10 wt %) |
| Example 24 | Same as Negative Electrode | S222FPFSI—LiFPFSI (0.8 mol/kg) + FEC (10 wt %) |
| Example 25 | Same as Negative Electrode | S222FNFSI—LiFNFSI (0.8 mol/kg) + FEC (10 wt %) |
| Example 26 | Same as Negative Electrode | S222FSI—LiFSI (0.8 mol/kg) + FEC (10 wt %) |
| Example 27 | Same as Negative Electrode | S223TFPSI—LiFSI (1.0 mol/kg) + FEC (5 wt %) |
| Comparative | Same as Negative Electrode | S222TFSI—LiTFSI (0.2 mol/kg) + |
| Example 1 | | LiCl (0.05 mol/kg) |
| Comparative | Same as Negative Electrode | 1 mol/kg LiPF₆-Methyldifluoroacetate |
| Example 2 | | |
| Comparative | Same as Negative Electrode | S222TFSI—LiTFSI (0.2 mol/kg) |
| Example 3 | | |
| Comparative | Same as Negative Electrode | S222TFSI—LiTFSI (0.2 mol/kg) |
| Example 4 | | |
| Comparative | Same as Negative Electrode | 0.6 mol/kg LiTFSI—FEC |
| Example 5 | | |
| Comparative | Same as Negative Electrode | 1MLiPF₆-Ethylene Carbonate |
| Example 6 | | |
| Comparative | Same as Negative Electrode | S222PF₆—LiPF₆ (0.4 mol/kg) |
| Example 7 | | |
| Comparative | Same as Negative Electrode | EMITFSI—LiTFSI (0.4 mol/kg) |
| Example 8 | | |
| Comparative | Same as Negative Electrode | S222TESI—LiTFSI (0.6 mol/kg) + FEC (10 wt %) |
| Example 9 | | |
| Comparative | Same Gel Electrolytic Solution | S222TESI—LiTFSI (0.6 mol/kg) + FEC (10 wt %) |
| Example 10 | as that of Negative Electrode | Gel Electrolytic Solution |

TABLE 5

| | Discharge | Average | | Cycle Life | 1 C Discharge |
|---|---|---|---|---|---|
| | Capacity | Voltage | Energy | Count at | Retention Ratio |
| | (Ah) | (V) | (Wh) | 60° C. | at 0° C. (%) |
| Example 1 | 2.7 | 2.8 | 7.56 | 600 | 70 |
| Example 2 | 1.5 | 3.4 | 5.1 | 850 | 80 |
| Example 3 | 1.5 | 3.4 | 5.1 | 800 | 82 |
| Example 4 | 1.5 | 3.4 | 5.1 | 700 | 70 |
| Example 5 | 1.5 | 2.4 | 5.1 | 650 | 65 |
| Example 6 | 1.5 | 3.4 | 5.1 | 900 | 70 |
| Example 7 | 1.5 | 3.4 | 5.1 | 800 | 80 |
| Example 8 | 1.6 | 3.4 | 5.44 | 800 | 90 |
| Example 9 | 1.8 | 3.7 | 6.66 | 700 | 82 |
| Example 10 | 3.0 | 1.6 | 4.8 | 800 | 80 |
| Example 11 | 3.1 | 1.6 | 4.98 | 850 | 85 |
| Example 12 | 3.1 | 1.6 | 4.96 | 860 | 90 |
| Example 13 | 3.1 | 1.6 | 4.96 | 800 | 92 |
| Example 14 | 2.5 | 2.0 | 5.0 | 600 | 85 |
| Example 15 | 2.2 | 1.55 | 3.41 | 1000 | 90 |
| Example 16 | 3.4 | 1.7 | 5.78 | 500 | 85 |
| Example 17 | 3.6 | 1.6 | 5.76 | 400 | 75 |
| Example 18 | 2.7 | 3.0 | 8.1 | 600 | 70 |
| Example 19 | 2.7 | 2.7 | 7.29 | 800 | 75 |

TABLE 6

| | Discharge | Average | | Cycle Life | 1 C Discharge |
|---|---|---|---|---|---|
| | Capacity | Voltage | Energy | Count at | Retention Ratio |
| | (Ah) | (V) | (Wh) | 60° C. | at 0° C. (%) |
| Example 20 | 2.6 | 2.7 | 7.02 | 500 | 80 |
| Example 21 | 2.7 | 2.8 | 7.56 | 600 | 72 |
| Example 22 | 2.65 | 2.8 | 7.42 | 550 | 75 |
| Example 23 | 1.5 | 3.4 | 5.1 | 900 | 85 |
| Example 24 | 1.5 | 3.4 | 5.1 | 950 | 85 |
| Example 25 | 1.5 | 3.4 | 5.1 | 980 | 85 |
| Example 26 | 1.5 | 3.4 | 5.1 | 980 | 80 |
| Example 27 | 1.8 | 3.7 | 6.66 | 750 | 85 |
| Comparative | 2.0 | 2.6 | 5.2 | 100 | 40 |
| Example 1 | | | | | |
| Comparative | 2.7 | 2.8 | 7.56 | 10 | 40 |
| Example 2 | | | | | |
| Comparative | 2.0 | 15 | 3.0 | 100 | 40 |
| Example 3 | | | | | |
| Comparative | 1.3 | 3.2 | 4.16 | 100 | 40 |
| Example 4 | | | | | |
| Comparative | 1.5 | 3.3 | 4.95 | 200 | 0 |
| Example 5 | | | | | |
| Comparative | 1.5 | 3.4 | 5.1 | 250 | 0 |
| Example 6 | | | | | |
| Comparative | 1.8 | 3.7 | 6.66 | 150 | 40 |
| Example 7 | | | | | |
| Comparative | 0.5 | 3.0 | 1.5 | 10 | 20 |
| Example 8 | | | | | |
| Comparative | 1.0 | 3.2 | 3.2 | 100 | 20 |
| Example 9 | | | | | |
| Comparative | 1.2 | 3.3 | 3.96 | 50 | 5 |
| Example 10 | | | | | |

As is apparent from Tables 1 to 6, the batteries of Examples 1 to 27 were excellent in high-temperature cycle life performance and low-temperature discharge rate performance, as compared with Comparative Examples 1 to 10.

A comparison between Example 3 and Examples 23 to 26 reveals that Examples 23 to 26, which included FTFSI, FPFSI, FNFSI or FSI in the anion components of the ionic liquid obtained a higher level of excellence in high-temperature cycle life performance as compared to Example 3.

Comparative Examples 1, 3, 4, and 7 included ionic liquids containing trialkyl sulfonium ions, but did not include an organic fluorine compound. Thus, the energy, the high-temperature cycle life performance, and the low-temperature discharge rate performance of Comparative Examples 1, 3, 4, and 7 were poorer than those of Example 1.

Since Comparative Example 2 neither included an organic fluorine compound nor used an ionic liquid, the high-temperature cycle life performance of Comparative Example 2 was poorer than that of Comparative Example 1.

Since the nonaqueous electrolytic solution of Comparative Example 5 was prepared by dissolving the lithium salt in the organic fluorine compound, the low-temperature discharge rate performance of Comparative Example 5 was significantly low.

Since Comparative Example 6 used an electrolytic solution not containing an ionic liquid and used a graphite negative electrode, the low-temperature discharge rate performance of Comparative Example 6 was significantly low.

Since Comparative Example 8 used an ionic liquid not containing trialkyl sulfonium ions, all of the energy, the high-temperature cycle life performance, and the low-temperature discharge rate performance of Comparative Example 8 were poorer than those of the Examples.

Since Comparative Example 9 used a graphite negative electrode, both the high-temperature cycle life performance and the low-temperature discharge rate performance of Comparative Example 9 were poorer than those of the Examples. The reason for this result is as follows: a reaction in which a coating is formed by an organic fluorine compound on the surface of the negative electrode occurs after initial charge; thus, reductive decomposition of trialkyl sulfonium ions progresses by then, to cause a high-resistance coating to grow on the surface of the negative electrode.

Since Comparative Example 10 used a gel electrolytic solution containing SiO₂ nanofibers, both the high-temperature cycle life performance and the low-temperature discharge rate performance of Comparative Example 10 were poorer than those of the Examples. The reason for this result is as follows: lithium ions of the gel electrolytic solution were not diffused evenly on the surface of the lithium metal negative electrode, causing an increase in the overvoltage, and a reaction for forming a coating with the use of the organic fluorine compound occurred unevenly, thereby causing the reductive decomposition of trialkyl sulfonium ions to advance.

### Example 28

As a positive electrode active material, lithium-nickel-cobalt-manganese oxide (LiNi_{0.8}Co_{0.1}Mn_{0.1}O₂) particles having an average particle size of 5 μm were used. 4% by weight of acetylene black and 2% by weight of graphite powder as electro-conductive agents, and 2% by weight of PVdF as a binder were mixed with the positive electrode active material. The respective mixing amounts are represented by a value based on the weight of the whole positive electrode active material-containing layer as 100% by weight. These materials were dispersed in an n-methylpyrrolidone (NMP) solvent to prepare a slurry, which was then applied to a current collector foil made of aluminum having a thickness of 10 μm, dried, and pressed, to thereby produce a positive electrode including the positive electrode active material-containing layer having a density of 3.3 g/cm³.

100 parts by weight of Al₂O₃ particles having an average particle size of 1 μm, and 4 parts by weight of polyvinylidene fluoride were dispersed in NMP to prepare a slurry. The slurry was applied onto both of the principal surfaces of the positive electrode active material-containing layer, and dried to thereby form an alumina particle layer having a thickness of 3 μm.

The negative electrode was produced by pressure-attaching a lithium metal foil having a thickness of 50 μm onto a copper current collector foil having a thickness of 10 μm.

As a separator, a porous layer made of a cellulose non-woven fabric having a thickness of 30 μm was prepared. As a nonaqueous electrolyte, an ionic liquid was produced by mixing 1 mol/kg of LiFSI in S₂₂₂TFSI of triethylsulfonium salt. A molar ratio FSI⁺:TFSI⁻ between FSI⁺ as a first anion and TFSI⁻ as a second anion was 1:2. Also, a molar ratio Li⁺:S222⁺ between the lithium ions and the triethyl sulfonium ions S222⁺ was 1:2. The porous layer was impregnated with the ionic liquid.

The positive electrode and the negative electrode were alternately stacked with the separator interposed therebetween to produce an electrode group. This electrode group was housed in a container made of an aluminum-containing laminated film having a thickness of 0.1 mm, thereby producing a thin secondary battery having the structure shown in FIG. 2. The secondary battery had a size of 12 mm×30 mm×50 mm, a capacity of 2.0 Ah, an intermediate voltage of 3.75 V, and a weight of 28 g.

### Examples 29 to 39

Thin secondary batteries were produced in the same manner as described in Example 28, except that the compositions of the ionic liquids, that is, the molar ratio between the first anion and the second anion, and the molar ratio between the lithium ions and the trialkyl sulfonium ions were changed as shown in Table 7.

The ionic liquid of Example 38 was prepared by mixing 2.17 mol/kg of LiFSI and 0.217 mol/kg of LiPF₆ in S₂₂₂TFSI. Since FSI⁻: TFSI⁻: PF₆⁻=1:0.9:0.1, the molar ratio between the first anion and the second anion was 1:1. Since Li⁺: S222⁺=1.1:0.9, the molar ratio between the lithium ions and the trialkyl sulfonium ions was 1:0.818. On the other hand, the ionic liquid of Example 39 was prepared by mixing 2.2 mol/kg of LiFSI and 0.22 mol/kg of LiBF₄ in S₂₂₂TFSI. Since FSI⁻: TFSI⁻: BF₄⁻=1:0.9:0.1, the molar ratio between the first anion and the second anion was 1:1. Since Li⁺: S222⁺=1.1:0.9, the molar ratio between the lithium ions and the trialkyl sulfonium ions was 1:0.818.

### Example 40

A liquid nonaqueous electrolyte was prepared by adding 0.1% by weight of FEC to S₂₂₂TFSI of triethylsulfonium salt, and dissolving 1 mol/kg of LiFSI therein. The molar ratio between the first anion and the second anion and the molar ratio between the lithium ions and the trialkyl sulfonium ions of the obtained nonaqueous electrolyte are shown in Table 7. A thin secondary battery was produced in the same manner as described in Example 28, except that this nonaqueous electrolyte was used.

### Examples 41 to 45

Thin secondary batteries were produced in the same manner as described in Example 28, except that the molar ratio between the first anion and the second anion, the molar ratio between the lithium ions and the trialkyl sulfonium ions, and the content of the organic fluorine compound were changed as shown in Table 7.

### Example 46

A foil made of a Li_{0.9}Mg_{0.1} alloy and having a thickness of 50 μm was pressure-attached onto a current collector made of a copper foil and having a thickness of 10 μm to produce a negative electrode. A thin secondary battery was produced in the same manner as described in Example 43, except that this negative electrode was used.

### Example 47

A positive electrode was produced in the same manner as described in Example 28, except that lithium iron phosphate (LiFePO₄) particles of an olivine structure having an average primary particle size of 0.1 μm and having carbon fine particles (average particle size: 0.005 μm) adhered onto the surface thereof (adherence amount: 0.1% by weight) was used as the positive electrode active material. Also, a negative electrode was produced in the same manner as described in Example 46. A thin secondary battery was produced in the same manner as described in Example 46, except that the positive electrode and the negative electrode thus obtained were used.

### Example 48

A positive electrode was produced in the same manner as described in Example 28, except that LiMn₂O₄ particles of a spinel structure having an average particle size of 3 μm were used as the positive electrode active material. A thin secondary battery was produced in the same manner as described in Example 28, except that the positive electrode thus obtained was used.

### Example 49

A positive electrode was produced in the same manner as described in Example 28, except that lithium-nickel-cobalt-manganese oxide (LiNi_{0.5}Co_{0.2}Mn_{0.3}O₂) particles having an average particle size of 5 μm were used as the positive electrode active material. A thin secondary battery was produced in the same manner as described in Example 28, except that the positive electrode thus obtained was used.

### Example 50

Graphite powder and polyvinylidene fluoride (PVdF) were mixed at a weight ratio of 90:10, and the resulting mixture was kneaded in the presence of as an organic solvent N-methylpyrrolidone to prepare a slurry. The obtained slurry was applied to a copper foil having a thickness of 15 μm, dried, and pressed, to thereby obtain a negative electrode. A thin secondary battery was produced in the same manner as described in Example 28, except that the negative electrode thus obtained was used.

### Example 51 and Comparative Examples 11 to 20

Thin secondary batteries were produced in the same manner as described in Example 28, except that the compositions of the ionic liquids, that is, the molar ratio between the first anion and the second anion, and the molar ratio between the lithium ions and the trialkyl sulfonium ions, were changed as shown in Table 8. EMI represents 1-ethyl-3-methylimidazolium.

After the respective secondary batteries were charged with a constant current of 0.2 A at 25° C. to reach 4.2 V, the discharge capacity (Ah) for discharging with 0.2 A to reach 2.7 V, the average voltage (V=Wh/Ah), and the energy (Wh) were measured. As a charge-and-discharge cycling test, charge with a constant current of 0.2 A at 25° C. was performed to reach 4.2 V and then discharge with 0.2 A was performed to reach 2.7 V, the charge-and-discharge cycle was repeated to determine the number of cycles at which the capacity retention ratio became 80% as a cycle life count. After charging the secondary batteries with a constant current of 0.2 A at 25° C. to reach 4.2 V, a discharge capacity C3 for discharging at a rate of 2 C (4 A) at 25° C. to reach 2.7 V was measured. Also, after charging the secondary batteries with a constant current of 0.2 A at 25° C. to reach 4.2 V, a discharge capacity C4 for discharging at a rate of 0.1 C (0.2 A) at 25° C. to reach 2.7 V was measured. A value of C3/C4 was obtained as a discharge capacity retention ratio with 2 C at 25° C. The results of the measurement are shown in Tables 9 and 10 below.

TABLE 7

| | | | Organic | Neg- |
|---|---|---|---|---|
| | | Molar Ratio Between | Fluorine | ative |
| | Positive Electrode | First and Second Anions, | Compound | Elec- |
| | Active Material | Molar Ratio between Cations | (wt %) | trode |
| Example 28 | LiNi_{0.8}Co_{0.1}Mn_{0.1}O₂ | FSI⁻:TFSI⁻ = 1:2, Li⁺:S222⁺ = 1:2 | None | Li |
| Example 29 | LiNi_{0.8}Co_{0.1}Mn_{0.1}O₂ | FSI⁻:TFSI⁻ = 1:3, Li⁺:S222⁺ = 1:3 | None | Li |
| Example 30 | LiNi_{0.8}Co_{0.1}Mn_{0.1}O₂ | FSI⁻:TFSI⁻ = 1:4, Li⁺:S222⁺ = 1:4 | None | Li |
| Example 31 | LiNi_{0.8}Co_{0.1}Mn_{0.1}O₂ | FSI⁻:TFSI⁻ = 2:3, Li⁺:S222⁺ = 2:3 | None | Li |
| Example 32 | LiNi_{0.8}Co_{0.1}Mn_{0.1}O₂ | FSI⁻:TFSI⁻ = 1:1, Li⁺:S222⁺ = 1:1 | None | Li |
| Example 33 | LiNi_{0.8}Co_{0.1}Mn_{0.1}O₂ | FSI⁻:TFSI⁻ = 2:1, Li⁺:S222⁺ = 2:1 | None | Li |
| Example 34 | LiNi_{0.8}Co_{0.1}Mn_{0.1}O₂ | FSI⁻:TFSI⁻ = 4:1, Li⁺:S222⁺ = 4:1 | None | Li |
| Example 35 | LiNi_{0.8}Co_{0.1}Mn_{0.1}O₂ | FSI⁻:FTFSI⁻ = 1:1, Li⁺:S222⁺ = 1:1 | None | Li |
| Example 36 | LiNi_{0.8}Co_{0.1}Mn_{0.1}O₂ | FSI⁻:FPFSI⁻ = 1:1, Li⁺:S222⁺ = 1:1 | None | Li |
| Example 37 | LiNi_{0.8}Co_{0.1}Mn_{0.1}O₂ | FSI⁻:FNFSI⁻ = 1:1, Li⁺:S222⁺ = 1:1 | None | Li |
| Example 38 | LiNi_{0.8}Co_{0.1}Mn_{0.1}O₂ | FSI⁻:FFSI⁻:PF₆⁻ = 1:0.9:0.1, Li⁺:S222⁺ = 1.1:0.9 | None | Li |
| Example 39 | LiNi_{0.8}Co_{0.1}Mn_{0.1}O₂ | FSI⁻:TFSI⁻:BF₄⁻ = 1:0.9:0.1, Li⁺:S222⁺ = 1.1:0.9 | None | Li |
| Example 40 | LiNi_{0.8}Co_{0.1}Mn_{0.1}O₂ | FSI⁻:TFSI⁻ = 1:2, Li⁺:S222⁺ = 1:2 | FEC(0.1) | Li |
| Example 41 | LiNi_{0.8}Co_{0.1}Mn_{0.1}O₂ | FSI⁻:TFSI⁻ = 1:2, Li⁺:S222⁺ = 1:2 | FEC(2) | Li |
| Example 42 | LiNi_{0.8}Co_{0.1}Mn_{0.1}O₂ | FSI⁻:TFSI⁻ = 1:2, Li⁺:S222⁺ = 1:2 | FEC(5) | Li |
| Example 43 | LiNi_{0.8}Co_{0.1}Mn_{0.1}O₂ | FSI⁻:TFSI⁻ = 1:1, Li⁺:S222⁺ = 1:1 | FEC(5) | Li |
| Example 44 | LiNi_{0.8}Co_{0.1}Mn_{0.1}O₂ | FSI⁻:TFSI⁻ = 2:1, Li⁺:S222⁺ = 2:1 | FEC(5) | Li |
| Example 45 | LiNi_{0.8}Co_{0.1}Mn_{0.1}O₂ | FSI⁻:TFSI⁻ = 4:1, Li⁺:S222⁺ = 4:1 | FEC(10) | Li |

TABLE 8

| | Positive | Molar Ratio Between | Organic | |
|---|---|---|---|---|
| | Electrode | First and Second Anions, | Fluorine | |
| | Active | Molar Ratio | Compound | Negative |
| | Material | between Cations | (wt %) | Electrode |
| Example 46 | LiNi_{0.8}Co_{0.1}Mn_{0.1}O₂ | FSI⁻:TFSI⁻ = 1:1, Li⁺:S222⁺ = 1:1 | FEC(S) | Li_{0.9}Mg_{0.1} Alloy |
| Example 47 | LiFePO₄ | FSI⁻:TFSI⁻ = 1:1, Li⁺:S222⁺ = 1:1 | FEC(5) | Li_{0.9}Mg_{0.1} Alloy |
| Example 48 | LiMn₂O₄ | FSI⁻:TFSI⁻ = 1:2, Li⁺:S222⁺ = 1:2 | None | Li |
| Example 49 | LiNi_{0.8}Co_{0.1}Mn_{0.1}O₂ | FSI⁻:TFSI⁻ = 1:2, Li⁺:S222⁺ = 1:2 | None | Li |
| Example 50 | LiNi_{0.8}Co_{0.1}Mn_{0.1}O₂ | FSI⁻:TFSI⁻ = 1:2, Li⁺:S222⁺ = 1:2 | None | Graphite |
| Example 51 | LiNi_{0.8}Co_{0.1}Mn_{0.1}O₂ | FSI⁻:TFSI⁻ = 1:2, Li⁺:S123⁺ = 1:2 | None | Li |
| Comparative Example 11 | LiNi_{0.8}Co_{0.1}Mn_{0.1}O₂ | TFSI⁻:TFSI⁻ = 1:5, Li⁺:EMI⁺ = 1:5 | None | Li |
| Comparative Example 12 | LiNi_{0.8}Co_{0.1}Mn_{0.1}O₂ | TFSI⁻:TFSI⁻ = 1:2, Li⁺:EMI⁺ = 1:2 | None | Li |
| Comparative Example 13 | LiNi_{0.8}Co_{0.1}Mn_{0.1}O₂ | FSI⁻:TFSI⁻ = 1:4, Li⁺:EMI⁺ = 1:4 | None | Li |
| Comparative Example 14 | LiNi_{0.8}Co_{0.1}Mn_{0.1}O₂ | FSI⁻:FSI⁻ = 1:2, Li⁺:EMI⁺ = 1:2 | None | Li |
| Comparative Example 15 | LiNi_{0.8}Co_{0.1}Mn_{0.1}O₂ | TFSI⁻:TFSI⁻ = 1:5, Li⁺:S223⁺ = 1:5 | None | Li |
| Comparative Example 16 | LiNi_{0.8}Co_{0.1}Mn_{0.1}O₂ | TFSI⁻:TFSI⁻ = 5:1, Li⁺:S223⁺ = 5:1 | None | Li |
| Comparative Example 17 | LiNi_{0.8}Co_{0.1}Mn_{0.1}O₂ | FSI⁻:TFSI⁻ = 1:5, Li⁺:S222⁺ = 1:5 | None | Li |
| Comparative Example 18 | LiNi_{0.8}Co_{0.1}Mn_{0.1}O₂ | FSI⁻:TFSI⁻ = 5:1, Li⁺:S222⁺ = 5:1 | None | Li |
| Comparative Example 19 | LiNi_{0.8}Co_{0.1}Mn_{0.1}O₂ | FSI⁻:FSI⁻ = 1:5, Li⁺:S222⁺ = 1:5 | None | Li |
| Comparative Example 20 | LiNi_{0.8}Co_{0.1}Mn_{0.1}O₂ | FSI⁻:FSI⁻ = 5:1, Li⁺:S222⁺ = 5:1 | None | Li |

TABLE 9

| | Discharge | Average | | Cycle Life | 2 C Discharge |
|---|---|---|---|---|---|
| | Capacity | Voltage | Energy | Count | Retention |
| | (Ah) | (V) | (Wh) | at 25° C. | Ratio (%) |
| Example 28 | 2.0 | 3.75 | 7.5 | 850 | 80 |
| Example 29 | 1.95 | 3.7 | 7.22 | 700 | 70 |
| Example 30 | 1.9 | 3.65 | 6.94 | 650 | 65 |
| Example 31 | 2.0 | 3.7 | 7.4 | 850 | 75 |
| Example 32 | 1.9 | 3.7 | 7.4 | 850 | 75 |
| Example 33 | 1.9 | 3.65 | 6.94 | 800 | 70 |
| Example 34 | 1.85 | 3.6 | 6.66 | 780 | 60 |
| Example 35 | 1.9 | 3.7 | 7.4 | 880 | 80 |
| Example 36 | 1.85 | 3.65 | 6.75 | 900 | 70 |
| Example 37 | 1.85 | 3.65 | 6.75 | 900 | 70 |
| Example 38 | 1.9 | 3.7 | 7.03 | 920 | 72 |
| Example 39 | 1.9 | 3.7 | 7.03 | 920 | 72 |
| Example 40 | 2.0 | 3.75 | 7.5 | 900 | 82 |
| Example 41 | 2.0 | 3.75 | 7.5 | 950 | 85 |
| Example 42 | 2.05 | 3.75 | 7.69 | 980 | 86 |
| Example 43 | 1.9 | 3.7 | 7.4 | 950 | 80 |
| Example 44 | 1.9 | 3.7 | 7.4 | 900 | 75 |
| Example 45 | 1.85 | 3.6 | 6.66 | 920 | 65 |

TABLE 10

| | | Av- | | Cycle | 2 C |
|---|---|---|---|---|---|
| | Dis- | erage | | Life | Discharge |
| | charge | Vol- | | Count | Retention |
| | Capacity | tage | Energy | at | Ratio |
| | (Ah) | (V) | (Wh) | 25° C. | (%) |
| Example 46 | 1.9 | 3.7 | 7.03 | 950 | 80 |
| Example 47 | 1.5 | 3.4 | 5.1 | 1200 | 70 |
| Example 48 | 1.3 | 3.9 | 5.07 | 1000 | 85 |
| Example 49 | 1.75 | 3.7 | 6.475 | 1000 | 82 |
| Example 50 | 1.2 | 3.6 | 4.32 | 1500 | 86 |
| Example 51 | 1.9 | 3.7 | 7.03 | 1000 | 85 |
| Comparative Example 11 | 1.85 | 3.6 | 6.66 | 70 | 40 |
| Comparative Example 12 | 1.80 | 3.6 | 6.48 | 50 | 20 |
| Comparative Example 13 | 1.9 | 3.7 | 7.03 | 100 | 50 |
| Comparative Example 14 | 1.9 | 3.65 | 6.94 | 90 | 40 |
| Comparative Example 15 | 1.9 | 3.65 | 6.94 | 90 | 45 |
| Comparative Example 16 | 1.7 | 3.5 | 5.95 | 20 | 10 |
| Comparative Example 17 | 1.7 | 3.6 | 6.12 | 100 | 50 |
| Comparative Example 18 | 1.7 | 3.5 | 5.95 | 10 | 10 |
| Comparative Example 19 | 1.7 | 3.6 | 6.12 | 80 | 40 |
| Comparative Example 20 | 1.7 | 3.5 | 5.95 | 5 | 5 |

As is apparent from the results shown in Tables 7 to 10, Examples 28 to 51 were excellent in the 25° C. cycle life performance and 2 C discharge retention ratio, as compared with Comparative Examples 11 to 20.

A comparison among Examples 28 to 34 reveals that Examples 28, 29, and 31 to 33, in which the molar ratio between the first anion and the second anion satisfied 1:3 to 2:1 and the molar ratio between the lithium ions and the trialkyl sulfonium ions satisfied 1:3 to 2:1, were excellent in the 2 C discharge retention ratio, as compared with Examples 30 and 34.

A comparison between Example 32 and Examples 35 to 39 reveals that Examples 32 and 35, which used TFSI⁻ or FTFSI⁻ as the second anion exhibited higher energy than those of Examples 36 to 39.

A comparison between Example 28 and Examples 40 to 45 reveals that Examples 40 to 45, which included an organic fluorine compound were excellent in cycle life performance, as compared with Example 28.

The results of Examples 47 to 49 demonstrate that a secondary battery excellent in cycle life performance and the 2 C discharge retention ratio can be realized when a lithium metal oxide which allows lithium ions to be inserted and extracted is used as a positive electrode active material.

The results of Examples 46, 47, and 50 demonstrate that a secondary battery excellent in the cycle life performance and the 2 C discharge retention ratio can be realized even when a Li alloy or a compound capable of having Li inserted and extracted is used as a negative electrode active material instead of metal Li.

As shown in Comparative Examples 11 to 14, when the cation was not trialkyl sulfonium ions, the cycle life performance and the 2 C discharge retention ratio were poor irrespective of the molar ratio.

As shown in Comparative Examples 15 and 16, even when the second anion and trialkyl sulfonium ions were used, when the first anion was not used, the cycle life performance and the 2 C discharge retention ratio were poor.

As shown in Comparative Examples 17 and 18, even when the first anion, the second anion, and trialkyl sulfonium ions were used, the cycle life performance and the 2 C discharge retention ratio were poor when the molar ratio was 1:5 or 5:1.

As shown in Comparative Examples 19 and 20, even when trialkyl sulfonium ions were used, the cycle life performance and the 2 C discharge retention ratio were poor when the type of anion was only FSI⁻.

The secondary battery of at least one embodiment or Example described above includes a negative electrode, which includes one or more selected from the group consisting of lithium metal and a lithium alloy as a negative electrode active material, and a nonaqueous electrolytic solution, which contains an ionic liquid containing trialkyl sulfonium ions and an organic fluorine compound; therefore, the secondary battery of at least one embodiment or Example described above can provide a secondary battery which has a high energy density and exhibits excellent performance in both high-temperature cycle and low-temperature. Moreover, the secondary battery, by virtue of its high energy density, is suitable for a stationary power supply and space applications.

Also, the nonaqueous electrolyte of an embodiment includes an ionic liquid including: a cation including trialkyl sulfonium ions and lithium ions; a first anion of [N(FSO₂)₂]⁻; and a second anion including one or more selected from the group consisting of [N(CF₃SO₂)₂]⁻, [N(FSO₂)(CF₃SO₂]⁻, [N(FSO₂)(C₂F₅SO₂)]⁻, [N(FSO₂)(n-C₄F₅SO₂)]⁻, PF₆⁻, and BF₄⁻. The molar ratio between the first anion and the second anion is in the range of 1:4 to 4:1, and the molar ratio between the lithium ions and the trialkyl sulfonium ions is in the range of 1:4 to 4:1. Thus, a nonaqueous electrolyte can be provided which can maintain the liquid state over a wide temperature range and exhibit ionic conductivity over the wide temperature range. Accordingly, the nonaqueous electrolyte of the embodiment can be used not only for a nonaqueous electrolyte of power storage devices (such as a secondary battery and a capacitor) for automobiles, industrial applications and space applications, but also for a medium for material synthesis, an actuator, and an electrolyte for a sensitizing solar cell, etc.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A secondary battery, comprising:
a positive electrode;
a negative electrode comprising lithium metal and/or a lithium alloy as a negative electrode active material; and
a liquid nonaqueous electrolyte comprising an ionic liquid and 0.5% by weight to 30% by weight of an organic fluorine compound,
wherein the ionic liquid comprises: a cation comprising a trialkyl sulfonium ion and a lithium ion; and an anion comprising one or more selected from the group consisting of [N(CF₃SO₂)₂]⁻, [N(FSO₂)₂]⁻, [N(FSO₂)(CF₃SO₂)]⁻, [N(FSO₂)(C₂F₅SO₂)]⁻, [N(FSO₂)(n-C₄F₉SO₂)]⁻, Cl⁻, PF₆⁻, and BF₄⁻.

2. The secondary battery according to claim 1, wherein the trialkyl sulfonium ion is one or more selected from the group consisting of a triethylsulfonium ion, a trimethylsulfonium ion, and a methylethylpropylsulfonium ion.

3. The secondary battery according to claim 1, wherein the organic fluorine compound is one or more selected from the group consisting of fluorinated ester and fluorinated ether.

4. The secondary battery according to claim 3, wherein: the fluorinated ester is one or more selected from the group consisting of fluoroethylene carbonate, difluoroethylene carbonate, and 2,2,2-trifluoroethylmethylcarbonate; and the fluorinated ether is 1,1,2,2-tetrafluoro-2,2,2-trifluoroethylether.

5. The secondary battery according to claim 1, wherein
a liquid nonaqueous electrolyte which comes into contact with the negative electrode is said liquid nonaqueous electrolyte, and
a liquid nonaqueous electrolyte which comes into contact with the positive electrode is an ionic liquid comprising: a cation comprising a trialkyl sulfonium ion and a lithium ion; and an anion comprising one or more selected from the group consisting of [N(CF₃SO₂)₂]⁻, [N(FSO₂)₂]⁻, [N(FSO₂)(CF₃SO₂)]⁻, [N(FSO₂)(C₂F₅SO₂)]⁻, [N(FSO₂)(n-C₄F₉SO₂)]⁻, Cl⁻, PF₆⁻, and BF₄⁻.

6. A nonaqueous electrolyte comprising an ionic liquid comprising: a cation comprising a trialkyl sulfonium ion and a lithium ion; a first anion of [N(FSO₂)₂]⁻; and a second anion comprising one or more selected from the group consisting of [N(CF₃SO₂)₂]⁻, [N(FSO₂)(CF₃SO₂)]⁻, [N(FSO₂)(C₂F₅SO₂)]⁻, [N(FSO₂)(n-C₄F₉SO₂)]⁻, PF₆⁻, and BF₄⁻,
wherein a molar ratio between the first anion and the second anion is in a range of 1:4 to 4:1, and a molar ratio between the lithium ion and the trialkyl sulfonium ion is in a range of 1:4 to 4:1.

7. The nonaqueous electrolyte according to claim 6, wherein a molar ratio between the first anion and the second anion is in a range of 1:3 to 2:1, and a molar ratio between the lithium ion and the trialkyl sulfonium ion is in a range of 1:3 to 2:1.

8. The nonaqueous electrolyte according to claim 6, comprising 0.1% by weight to 10% by weight of an organic fluorine compound.

9. A secondary battery comprising:
a positive electrode configured to have lithium ions inserted and extracted;
a negative electrode configured to have lithium ions inserted and extracted; and
the nonaqueous electrolyte according to claim 6.

10. A battery pack comprising the secondary battery according to claim 1.

11. The battery pack according to claim 10, further comprising:
an external power distribution terminal; and
a protective circuit.

12. The battery pack according to claim 10,
comprising a plurality of the secondary battery,
wherein the secondary batteries are electrically connected in series, in parallel, or in a combination of in series and in parallel.

13. A vehicle comprising the battery pack according to claim 10.

14. A stationary power supply comprising the battery pack according to claim 10.

15. A battery pack comprising the secondary battery according to claim 9.

16. A vehicle comprising the battery pack according to claim 15.

17. A stationary power supply comprising the battery pack according to claim 15.
